(19) United States
(12) Patent Application Publication
(10) Pub. No.: US 2002/0138442 A1
(43) Pub. Date: Sep. 26, 2002

(54) Content provision device and method and license server capable of facilitating circulation of encrypted content data

(75) Inventors: Yoshihiro Hori, Gifu-shi (JP); Toshiaki Hioki, Ogaki-shi (JP)

Correspondence Address: ARMSTRONG,WESTERMAN & HATTORI, LLP, 1725 K STREET, NW., SUITE 1000, WASHINGTON, DC, 20006, US

(73) Assignee: Sanyo Electric Co., Ltd., Moriguchi-shi (JP)

(21) Appl. No.: 09/949,787

(22) Filed: Sep. 12, 2001

(30) Foreign Application Priority Data
Mar. 26, 2001 (JP) 2001-086731(P)

(51) Int. Cl. G06F 17/60

(52) U.S. Cl. 705/59; 705/51

(57) ABSTRACT

A personal computer obtains music data and identification information of the music data from a CD and transmits the identification information to a license management server on the Internet. The personal computer receives an encryption key and additional information of the music data from the license management server. The personal computer encodes the music data in an MP3 system to generate content data and encrypts the content data with an encryption key to generate encrypted content data, and uploads the encrypted content data to the personal computer together with the additional information. Thus, while copyright can be protected, encrypted content data can be generated and provided to a site allowing each user to obtain the same.

### BACKGROUND OF THE INVENTION

1. Field of the Invention

The present invention relates to content provision devices and methods and license servers in a data distribution system capable of copyright protection for copied information.

2. Description of the Background Art

In recent years the Internet and other similar information communication networks have advanced and a cellular phone or the like is used for a personal terminal to allow the user to readily access network information.

On such an information communication network a digital signal is used to transmit information. As such, if a user copies music, video data or the like transmitted on such an information communication network as described above, each individual user can copy such data almost free of significant degradation in the quality of sound, image and the like.

Thus, if content data, such as music data, image data or any other similar creations are transmitted on such an information communication network without any appropriate approach taken to protect the copyright, the copyright owner may have his/her right infringed significantly.

However, prioritizing copyright protection and preventing distribution of content data on a rapidly expanding information communication work, is disadvantageous to copyright owners, who basically can collect a predetermined copyright fee for copying content data.

In contrast, if digital data recorded in a recording medium, e.g., music data recorded in a normally sold compact disc (CD), is copied to a magneto-optical disk (such as an MD), it may be copied, as desired, as long as the copied data is solely for personal use, although an individual user who example digitally records data is required to indirectly pay as a bond to the copyright owner a predetermined portion of the price of the exact digital recording equipment, MD or any other similar media used by the user.

In addition, if music data in a digital signal is copied from a CD to an MD the information is digital data copied without significant degradation and accordingly equipment is configured to prevent copying music data from a recordable MD to another MD and thus protect copyright.

As such, distributing music data, image data and other similar data to the public on an information communication network is itself a behavior subject to a restriction attributed to a public transmission right of a copyright owner and a sufficient approach is accordingly required for protection of copyright.

This requires preventing further, arbitrarily copying content data corresponding to copyrighted creations such as music data and image data that has been transmitted to the public on an information communication network and received.

Accordingly there has been proposed a data distribution system wherein a distribution server holding encrypted content data distributes the encrypted content data via a terminal device such as a cellular phone to a memory card attached to the terminal device. In this data distribution system, a public encryption key of a memory card that is previously authenticated by an authentication station and a certificate thereof are transmitted to a distribution server when a request is issued for distribution of encrypted content data. When the distribution server confirms that the received certificate is an authenticated certificate, it transmits to the memory card the encrypted content data and a license key provided to decrypt the encrypted content data. In distributing the encrypted content data and the license key, the distribution server and the memory card generate a different session key for each distribution and use the session key to encrypt a public encryption key and exchange a key therebetween.

Finally the distribution server transmits to the memory card a license encrypted with a public encryption key of each individual memory card and further encrypted with a session key and the encrypted content data. The memory card receives and records the license and the encrypted content data therein.

To reproduce the encrypted content data recorded in the memory card, the memory card is attached to a reproduction device. The reproduction device can have a normal telephone function and in addition thereto a circuit dedicated to decrypting the encrypted content data received from the memory card, reproducing the data and outputting it externally to serve as a reproduction terminal.

Thus the reproduction terminal can be used to receive and reproduce encrypted content data received from a distribution server.

Limiting a source of encrypted content data to a distribution server, however, can prevent content data from circulating as desired. Furthermore, if content data is music data it is often recorded in a CD and thus distributed. Circulation through media, however, has a limit in characteristics of circulation routes as it is costly and can only circulate a limited number of music data. As such it does not ensure desired circulation of music data, and music data less frequently purchased would inevitably be withdrawn from circulation, which is disadvantageous to the owner of the copyright thereof as well as users.

Furthermore the recent development of digital communication networks represented by the Internet allows a user to put on a home page operated by the user the music data recorded in a CD having purchased by the user, and another user to download the data, as desired. While such circulation based on replication between users, as desired, is convenient for the users, it significantly infringes on rights of copyright owners and should not be overlooked

### SUMMARY OF THE INVENTION

The present invention therefore contemplates a content provision device and method and license server protecting copyright and also generating encrypted content data and providing the generated, encrypted content data to a site allowing each user to obtain the data.

The present invention provides the content provision device obtaining content data and using an encryption key to encrypt the content data to provide encrypted content data, including: an interface controlling communication with a recording medium having the content data recorded therein; a transmission and reception unit allowing external communication; an encryption unit using the encryption key to encrypt the content data to generate the encrypted content data; and a control unit obtaining the content data and identification information of the content data from the recording medium through the interface, transmitting the identification information via the transmission and reception unit to a license management server holding the encryption key, receiving the encryption key from the license management server via the transmission and reception unit, providing to the encryption unit the content data and the encryption key received, and providing externally via the transmission and reception unit the encrypted content data generated by the encryption unit.

Preferably the control unit receives from the license management server via the transmission and reception unit additional information including information required for obtaining a decryption key provided to decrypt the encrypted content data, and provides the additional information externally together with the encrypted content data.

Preferably when the control unit receives authentication data of the license management server via the transmission and reception unit, authenticates the authentication data received, and establishes a communication path communicating with the license management server, the control unit transmits the identification information to the license management server via the transmission and reception unit.

Preferably the control unit communicates with the license management server in a predetermined encryption system.

Preferably the content provision devise further includes an encoding unit encoding the content data in a predetermined system, the encoding unit encoding content data obtained from the recording medium, in the predetermined system to generate encoded content data, wherein the encryption unit receives the encoded content data from the encoding unit and encrypts the encoded content data with the encryption key to generate encrypted content data.

Furthermore the present invention provides a method of providing content, comprising the steps of: obtaining content data and identification information of the content data from a recording medium; transmitting the identification information to a license management server; receiving an encryption key from the license management server; encrypting the content data with the encryption key to generate encrypted content data; and externally outputting the encrypted content data generated.

Preferably, the step of receiving includes further receiving additional information including information required for obtaining a decryption key provided to decrypt the encrypted content data, and the step of externally outputting includes externally outputting the additional information together with the encrypted content data.

Preferably the step of transmitting includes transmitting the identification information to the license management server when the license management server is authenticated.

Preferably the step of receiving includes allowing the license management server to communicate in a predetermined encryption system.

Preferably the step of encrypting includes encoding the content data obtained in the step of obtaining, in the predetermined system to generate encoded content data, and then encrypting the encoded content data with the encryption key to generate the encrypted content data.

Furthermore the present invention provides a license server providing an encryption key to a content provision device encrypting obtained content data and providing encrypted content data, including: a transmission and reception unit allowing an external communication; a database having stored therein a plurality of identification information corresponding to a plurality of content data, respectively, and the encryption key; and a control unit receiving via the transmission and reception unit identification information of the content data transmitted from the content provision device, and reading from the database the encryption key corresponding to the identification information of the content data received, for transmission via the transmission and reception unit to the content provision device having transmitted the identification information of the content data.

Preferably the database has stored therein additional information corresponding to the plurality of content data, respectively, and including information required for obtaining a decryption key provided to decrypt content data encrypted in the content provision device using the encryption key, and transmits together with the encryption key the additional information corresponding to the encryption key.

Preferably if the control unit transmits the encryption key to the content provision device having transmitted the identification information of the content data the control unit communicates with the content provision device in a predetermined encryption system.

Preferably, the control unit further provides to at least one terminal device having received the encrypted content data from the content provision device a decryption key provided to decrypt the encrypted content data, receives via the transmission and reception unit the identification information of the content data transmitted from the terminal device, reads from the database a decryption key corresponding to the identification information of the content data received, and transmits the decryption key via the transmission and reception unit to the terminal device having transmitted the identification information of the content data, and the database further has stored therein a plurality of decryption keys corresponding to the plurality of content data, respectively.

Preferably if the control unit transmits the decryption key to the terminal device having transmitted the identification information of the content data the control unit communicates with the terminal device in a predetermined encryption system.

The foregoing and other objects, features, aspects and advantages of the present invention will become more apparent from the following detailed description of the present invention when taken in conjunction with the accompanying drawings.

### BRIEF DESCRIPTION OF THE DRAWINGS

In the drawings:

FIG. 1 is a schematic diagram illustrating a concept of a distribution system;

FIG. 2 is a schematic block diagram showing a license management server shown in FIG. 1;

FIG. 3 is a schematic block diagram showing a personal computer communicating with the FIG. 1 license management server;

FIG. 4 is a flow chart of an operation generating and providing encrypted content data;

FIGS. 5 and 6 present characteristics of data, information and the like used for communication in the FIG. 1 distribution system between a license distribution server and a personal computer;

FIG. 7 is a schematic block diagram showing a configuration of the license distribution server in the FIG. 1 distribution system;

FIG. 8 is a schematic block diagram showing a personal computer communicating with the FIG. 1 license distribution server;

FIG. 9 is a schematic block diagram showing a configuration of a reproduction terminal in the FIG. 1 distribution system;

FIG. 10 is a schematic block diagram showing a configuration of a memory card in the FIG. 1 distribution system;

FIGS. 11-14 are first to fourth flow charts, respectively, of a license distribution operation shown in FIG. 1;

FIGS. 15-18 are first to fourth flow charts, respectively, of an operation effected to check out a license of encrypted content data in the FIG. distribution system;

FIGS. 19-21 are first to third flow charts, respectively, of an operation effected to check in a license of encrypted content data in the FIG. 1 distribution system; and

FIGS. 22 and 23 are first and second flow charts, respectively, of a reproduction operation in a reproduction terminal.

### DESCRIPTION OF THE PREFERRED EMBODIMENTS

An embodiment of the present invention will now be described more specifically with reference to the drawings. In the figures, like components are denoted by like reference characters.

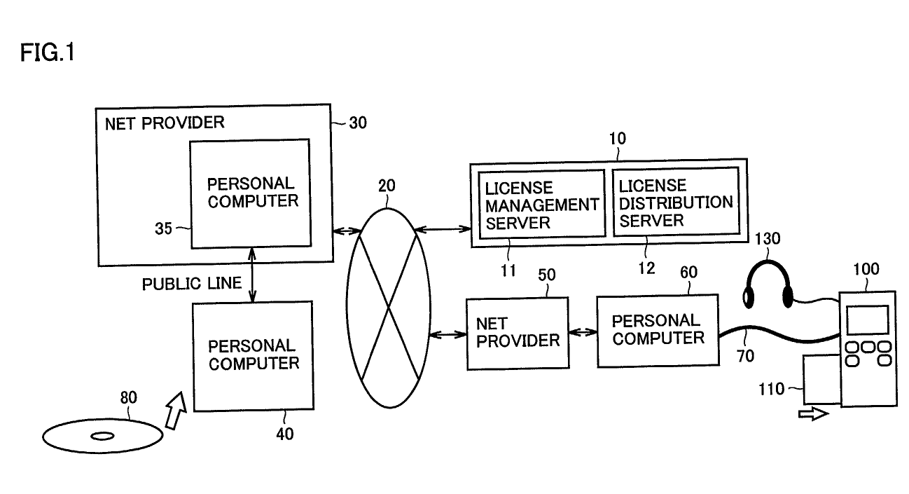

FIG. 1 is a schematic diagram for illustrating a concept of a general configuration of a data distribution system with a content provision device providing encrypted content data.

Note that hereinafter is described a configuration of a distribution system providing music data encrypted with an encryption key obtained from a server, via the Internet to a site allowing any user to obtain the encrypted music data, and distributing a license allowing a user to decrypt the encrypted music data obtained by the user, by way of example. As will be apparent from the following description, however, the present invention is not limited thereto and it is also applicable to distributing other copyrighted creations in the form of content data, such as image data, animated image data and the like.

A personal computer 40, a provider of encrypted content data corresponding to an encryption of music data, obtains from a CD 80 music data and content information corresponding to identification information of the music data. Then personal computer 40 and a license management server 11 of a distribution server 30 effect a mutual authentication via a net provider 30 and the Internet 20 and establish therebetween a secure socket layer (SSL) encryption communication path.

Personal computer 40 transmits the content information of the music data obtained from CD 80 to license management server 11 via the SSL encryption communication path. License management server 11 determines from the content information received from personal computer 40 whether a license key Kc may be provided and if so then it transmits license key Kc and additional information of the content data to personal computer 40. The “additional information” includes plaintext information on copyright such as a content ID provided to identify encrypted content data corresponding to music data encrypted with license key Kc, and server access such as information on connection to a license server. Personal computer 40 receives license key Kc encrypting the music data provided in the form of content data (hereinafter, music data will also be referred to as content data) and the additional information from license management server 11 via the SSL encryption communication path. Personal computer 40 allows an incorporated content generation module to encode the content data obtained from CD 80, for example in the moving picture encoding group (MPEG) audio layer 3 (MP3) system, encrypts the encoded content data with license key Kc received from license management server 11 and thus generates encrypted content data. Personal computer 40 provides the generated, encrypted content data and the additional information in a single train of data to a personal computer 35 of net provider 30. The encrypted content data and additional information provided to personal computer 35 can be downloaded as desired by any user (in FIG. 1, a user of a personal computer 60) via the Internet 20.

The user of personal computer 60 accesses personal computer 35 of net provider 30 via a net provider 50 and the Internet 20 and downloads via the Internet 20 the encrypted content data and additional information provided from personal computer 40. Personal computer 60 then refers to the downloaded additional information in response to a request from the user to extract content ID specifying encrypted content data, i.e., identification information specifying license key Kc, and connection information specifying a license distribution server 12 to connect with license distribution server 12. Personal computer 60 then refers to the connection information to connect with license distribution server 12 of distribution server 10 via net provider 50 and the Internet 20 and transmits to license distribution server 12 the content ID and a request for distribution of a license. Personal computer 60 thus receives from license distribution server 12 a license including license key Kc and corresponding to information used to decrypt and reproduce encrypted content data.

After license distribution server 12 effects a predetermined authentication process in response to a request from personal computer 60 for distribution of the content ID and the license, license distribution server 12 distributes to personal computer 60 via the Internet 20 a license including license key Kc specified from the content ID. A license distribution operation including the authentication process effected in license distribution server 12 will later be described more specifically.

Personal computer 60 transmits the obtained encrypted content data and license to a reproduction terminal 100 through a universal serial bus (USB) cable 70. Reproduction terminal 100 uses the license to decrypt and reproduce the received encrypted content data. Thus the user of reproduction terminal 100 can listen to music via a headphone 130. If personal computer 60 has a function similar to reproduction terminal 100, personal computer 60 can also reproduce data.

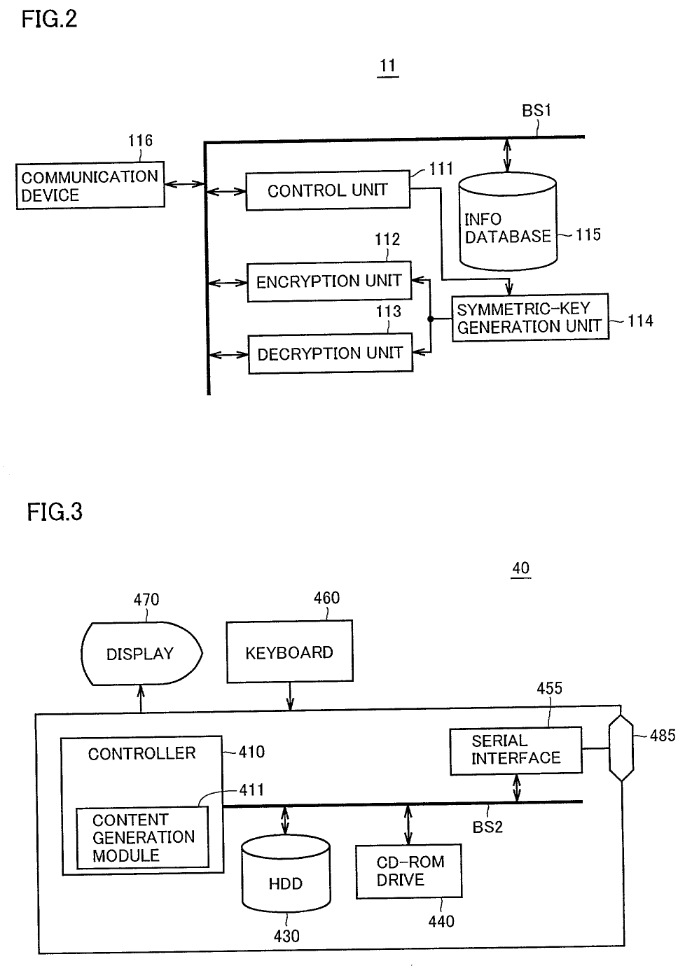

With reference to FIG. 2, license management server 11 includes a bus BS1, a control unit 111, an encryption unit 112, a decryption unit 113, a symmetric key generation unit 114, an information database 115, and a communication device 116. Bus BS1 communicates data with each component configuring license management server 11. Control unit 111 controls each component of license management server 11. Encryption unit 112 encrypts input data with a symmetric key Kcom generated by symmetric key generation unit 114. Decryption unit 113 decrypts input encrypted data with symmetric key Kcom. Symmetric key generation unit 114 generates symmetric key Kcom employed in the SSL encryption communication with personal computer 40 and outputs symmetric key Kcom to encryption unit 112 and decryption unit 113. Information database 115 holds license key Kc provided to encrypt content data, and additional information of the content data. Communication device 116 communicates data between the Internet 20 and bus BS1.

With reference to FIG. 3, personal computer 40 includes a bus BS2, a controller 410, a hard disk 430, a CD-ROM drive 440, a serial interface 455, a terminal 485, a keyboard 460, and a display 470. Controller 410 includes a content generation module 411.

Bus BS2 communicates data with each component of personal computer 40. Controller 410 controls each component of personal computer 40. Content generation module 411 employs software to encode content data in a predetermined system and encrypts the encoded content data to generate encrypted content data. More specifically, content generation module 411 encodes in the MP3 system the content data obtained from CD 80 via CD-ROM drive 440 and encrypts the encoded content data with license key Kc obtained from license management server 11 by controller 410 and thus generates encrypted content data.

Hard disk 430 holds a program configuring content generation module 411, a program of an operating system (OS) of personal computer 40, the content management module and the like in an non-effective state, and content data that is obtained from CD 80 via CD-ROM drive 440, encoded, and further encrypted with license key Kc received from license management server 11. Furthermore, hard disk 430 also holds additional information and the like received from license management server 11. CD-ROM drive 440 reads content data and content information from CD 80. Serial interface 455 controls data communication provided between bus BS2 and terminal 485. Terminal 485 connects with a public line via a modem (not shown). Keyboard 460 is used to input an instruction entered by a user of personal computer 40. Display 470 presents various visual information to the user of personal computer 40.

A description will now be provided of an operation effected in the FIG. 1 distribution system to allow personal computer 40 to download license key Kc and additional information of content data from license management server 11 of distribution server 10 and use the received license key Kc to generate encrypted content data and also provide the generated, encrypted content data to personal computer 35 of net provider 30.

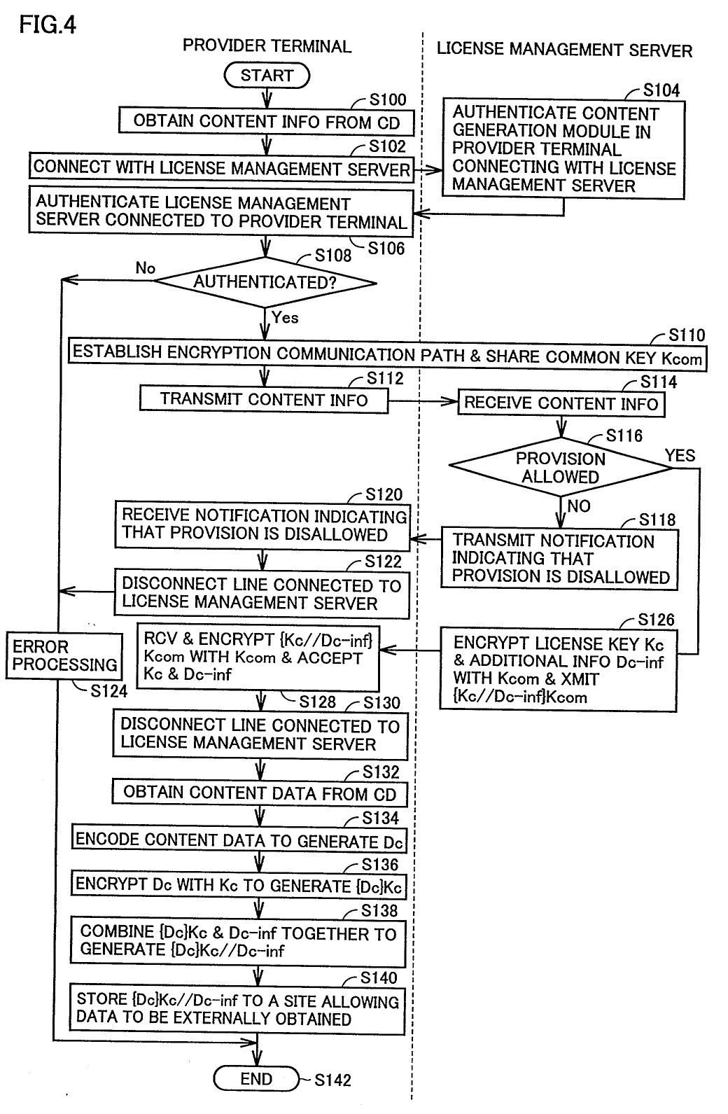

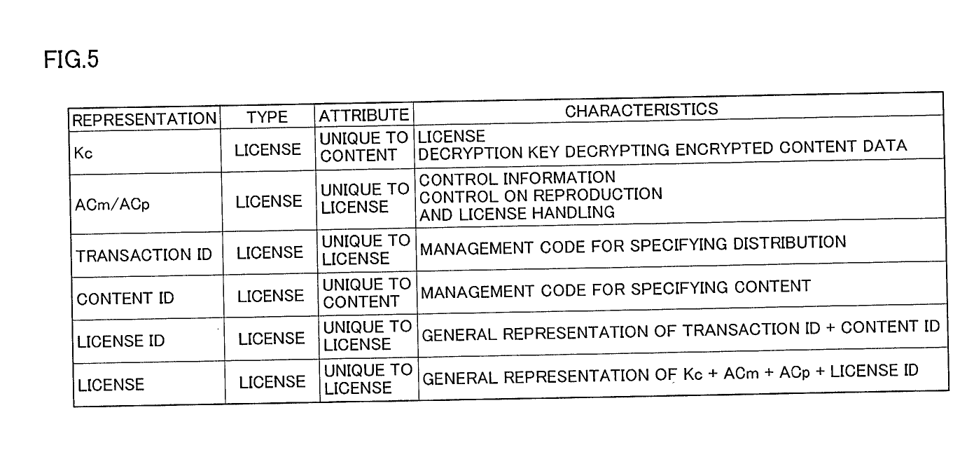

FIG. 4 is a flow chart of an operation effected to allow personal computer 40 to receive license key Kc and additional information from license management server 11, use license key Kc to encrypt content data to generate encrypted content data, which is in turn rendered accessible by a third party on the Internet 20 and uploaded to a personal computer 35 serving as an Internet server allowing the encrypted content data to be downloaded.

With reference to FIG. 4, in personal computer 40 controller 410 obtains content information from CD 80 via CD-ROM drive 440 to identify content (step S100). Controller 410 outputs a message through bus BS2, serial interface 455 and terminal 485 to establish a line communicating with license management server 11 and thus connects with license management server 11 (step S102). In doing so, controller 410 also transmits authentication data of content generation module 411 to license management server 11 together with the message provided to establish the line.

In license management server 11 control unit 111 receives via communication device 116 and through bus BS1 the message sent to establish the line and the authentication data. Control unit 111 uses the authentication data to authenticate content generation module 411 (step S104). When control unit 111 completes the authentication of content generation module 411, control unit 111 transmits authentication data of itself to personal computer 40 through bus BS1 and via communication device 116.

In personal computer 40 controller 410 receives the authentication data through terminal 485, serial interface 455 and bus BS2 and uses the received authentication data to effect an authentication process for license management server 11 (step S106). Controller 410 determines whether license management server 11 is authenticated (S 108) and if not then controller 410 provides an error-processing (step S124). Thus a series of operations ends (step S142).

If at step S108 license management server 11 is authenticated then controller 410 establishes an SSL encryption communication path communicating with license management server 11 (step S110). More specifically, controller 410 transmits to license management server 11 through bus BS2, serial interface 455 and terminal 485 candidates for an encryption system applied between controller 410 and license management server 11. In license management server 11 control unit 111 receives the candidates for the encryption system via communication device 116 and through bus BS1 and selects a candidate encryption system that it can apply, and control unit 111 outputs the result of the selection to symmetric key generation unit 114 and also to personal computer 40 through bus BS1 and via communication device 116. Symmetric key generation unit 114 generates symmetric key Kcom in the encryption system selected by control unit 111 and outputs the same to encryption unit 112 and decryption unit 113.

In personal computer 40 controller 410 receives through terminal 485, serial interface 455 and bus BS2 the encryption system selected by license management server 11 and generates symmetric key Kcom in the selected encryption system.

Thus, symmetric key Kcom for use in an encryption communication is prepared by license management server 11 and personal computer 40 and an SSL encryption communication path is established between license management server 11 and personal computer 40.

When an SSL encryption communication path is established, in personal computer 40 controller 410 reads content information from hard disk 430 through bus BS2 and encrypts the read content information with communication key Kcom. Controller 410 then transmits the encrypted content information to license management server 11 through bus BS2, serial interface 455 and terminal 485 (step S112). In license management server 11 control unit 111 receives the encrypted content information via communication device 116 and through bus BS1 and outputs the received content information to decryption unit 113 through bus BS1 (step S114). Decryption unit 113 decrypts the encrypted content information with symmetric key Kcom generated by symmetric key generation unit 114 and outputs content information. Control unit 111 obtains the content information through bus BS1 and from the obtained content information specifies content data and determines whether license key Kc may be provided to encrypt the content data (step S116). If control unit 111 determines that license key Kc may not be provided then control unit 111 generates a notification indicating that license key Kc may not be provided and inputs the notification to encryption unit 112. Encryption unit 112 encrypts the notification with symmetric key Kcom generated by symmetric key generation unit 114 and outputs the encrypted notification. Control unit 111 transmits the encrypted notification on bus BS1 and via communication device 116 to personal computer 40 (step S118).

In personal computer 40 controller 410 receives the encrypted notification through terminal 485, serial interface 455 and bus BS2, decrypts the received notification with symmetric key Kcom and accepts the notification (step S120). Controller 410 then disconnects the line communicating with license management server 11 (step S122) and effects an error-processing such as displaying on display 470 the notification indicating that license key Kc may not be provided (step S124). Thus a series of operation ends (step S142).

If in step S116 the control determines that license key Kc may be provided then in license management server 11 control unit 111 reads from information database 115 through bus BS1 license key Kc and additional information Dc-inf of content data specified by content information and provides license key Kc and additional information Dc-inf to encryption unit 112 through bus BS1. Encryption unit 112 uses symmetric key Kc to encrypt license key Kc and additional information Dc-inf to generate encrypted data {Kc//Dc-inf}Kcom. Control unit 111 transmits encrypted data {Kc//Dc-inf}Kcom on bus BS1 to personal computer 40 through bus BS1 and via communication device 116 (step S126).

In personal computer 40 controller 410 receives encrypted data {Kc//Dc-inf}Kcom through terminal 485, serial interface 455 and bus BS2, decrypts encrypted data {Kc//Dc-inf}Kcom with symmetric key Kcom, accepts license key Kc and additional information Dc-inf (step S128), and stores additional information Dc-inf alone to hard disc 430. Controller 410 then disconnects the line communicating with license management server 11 (step S130).

Controller 410 obtains content data from hard disk 430 through bus BS2 (step S132) and provides to content generation module 411 the obtained content data and license key Kc accepted at step S128. Content generation module 411 encodes the content data in the MP3 system to generate encoded content data Dc (step S134). Content generation module 411 then encrypts encoded content data Dc with license key Kc to generate encrypted content data {Dc}Kc (step S136) and stores it to hard disc 430.

Controller 410 then combines encrypted content data {Dc}Kc and additional information Dc-inf together to generate data {Dc}Kc//Dc-inf (step S138). Controller 410 then transmits data {Dc}Kc//Dc-inf through bus BS2, serial interface 455 and terminal 485 to personal computer 35 of net provider 30 (step S140) or uploads data {Dc}Kc//Dc-inf to personal computer 35 and causes personal computer 35 to hold data {Dc}Kc//Dc-inf to allow a third party to download data {Dc}Kc//Dc-inf, as desired. Thus the entire process end (step S412).

Thus, the user of personal computer 60 can obtain on the Internet 20 data {Dc}Kc//Dc-inf stored in personal computer 35.

Thus the user uses his/her personal computer 60 to access personal computer 35 of net provider 30 via the Internet 20 and download data {Dc}Kc//Dc-inf from personal computer 35. After the process ends, encrypted content data Dc, additional information Dc-inf and data {Dc}Kc//Dc-inf stored in personal computer 40 at hard disc 430 may be deleted therefrom.

As has been described above, personal computer 40 allows a user thereof to obtain content data from CD 80, and obtain license key Kc from license management server 11 to encrypt the content data and use the key to generate encrypted content data {Dc}Kc, as desired, and also upload the generated, encrypted content data {Dc}Kc to personal computer 35 of net provider 30. This allows other users to download encrypted content data {Dc}Kc from personal computer 35, as desired, and can thus facilitate circulating encrypted content data {Dc}Kc, as desired.

A description will now be provided of a license distribution operation allowing a user of the FIG. 1 personal computer 60 to download on the Internet 20 encrypted content data {Dc}Kc and additional information Dc-inf uploaded to personal computer 35, and receive from license distribution server 12 of distribution server 10 a license provided to decrypt and reproduce encrypted content data {Dc}Kc. A description will also be provided of an operation effected to allow personal computer 60 to transmit the downloaded, encrypted content data {Dc}Kc and the license through USB cable 70 to memory card 110 attached to reproduction terminal 100, and to reproduce encrypted content data {Dc}Kc recorded in memory card 110.

FIG. 5 presents data, information and the like used in communication in the FIG. 1 distribution system between license distribution server 12 and personal computer 60.

A license distributed from license distribution server 12 will initially be described. As the license, there exist license key Kc, a content ID, a transaction ID corresponding to a management code provided to specify distribution of a license from license distribution server 12, and access control information ACm generated from a license purchasing condition AC including for example a number of licenses and a limitation on a function that are determined, as designated by a user, and corresponding to information on a restriction imposed on accessing a license in a recording device (a memory card), reproduction control information ACp corresponding to information on controlling the reproduction in the data terminal device, and other similar information. More specifically, access control information ACm is control information used in externally outputting a license or a license key from a memory card, and it includes information on a restriction applied to a number of times of reproduction allowed (a number of times of outputting a license key for reproduction), a restriction applied to license transfer and replication, and the like. Reproduction control information ACp is information restricting reproduction after a content reproduction circuit receives a license key to reproduce encrypted content data, and reproduction control information ACp for example includes a term of reproduction, a restriction on changing a reproduction rate, a designation of a reproduction range (a partial license), and the like.

Hereinafter, a transaction ID and a content ID will generally be referred to as a license ID, and license key Kc, a license ID, access control information ACm and reproduction control information ACp will generally be referred to as a license. Furthermore, hereinafter, for the sake of simplicity, access control information ACm are two items, i.e., a number of times of reproduction corresponding to control information used to limit a number of times of reproduction (0: reproduction disallowed, 1 to 254: a number of times of reproduction allowed, and 255: no limit applied), and a transfer and replication flag restricting license transfer and replication (1: transfer and replication disallowed, 2: transfer alone allowed, and 3: transfer and replication prohibited), and reproduction control information ACp only restricts a term of reproduction (a UTC time code) corresponding to control information defining a term of reproduction allowed.

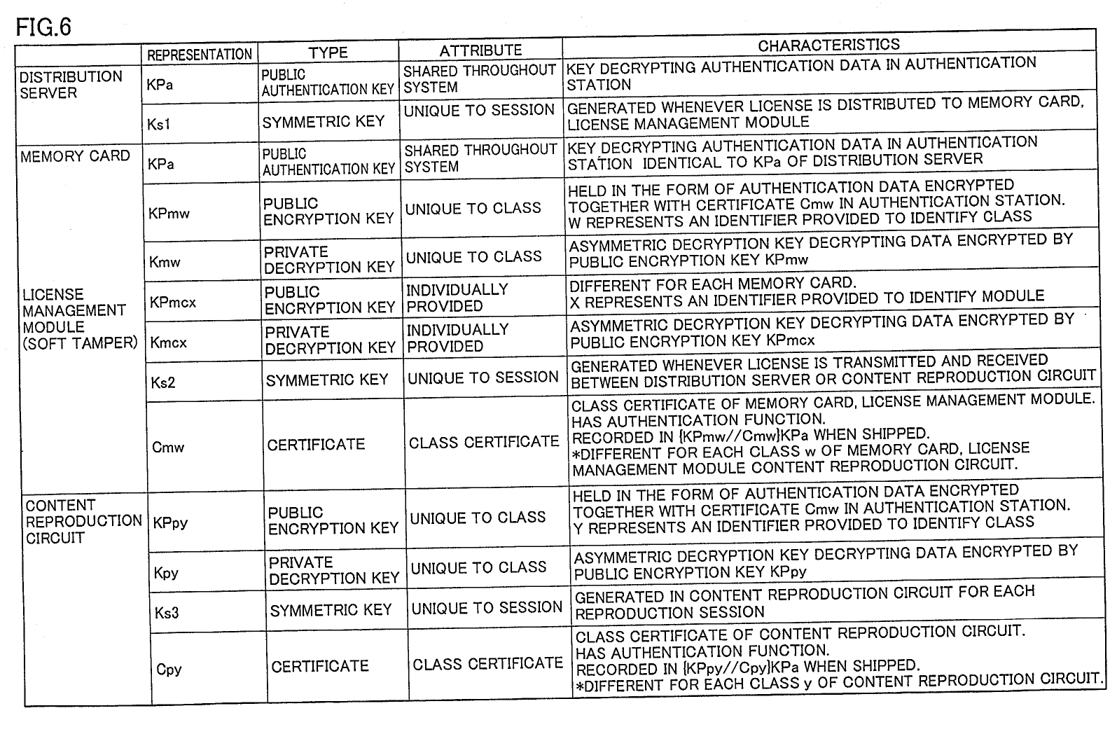

FIG. 6 presents characteristics of data, information and the like for an encryption process effected in the FIG. 1 distribution system for license protection employed in a content reproduction circuit provided in reproduction terminal 100, memory card 110, a license management module corresponding to a program executed on a personal computer 60 and providing a license management, and license management server 12.

A content reproduction circuit is provided with a unique public encryption key KPpy and a memory card and a license management module are provided with a unique public encryption key KPmw Public encryption keys KPpy and KPmw are decryptable with a private decryption key Kpy unique to the content reproduction circuit and a private decryption key Kmw unique to the memory card or the license management module, respectively. These public encryption and private decryption keys each have a different value for each content reproduction circuit type and each memory card or license management module type. These public encryption and private decryption keys will generally be referred to as a class key, and the public encryption keys will be referred to as a public encryption class key, the private decryption key will be referred to as a secret decryption class key and a unit sharing a class key will be referred to as a class. A class varies depending on the manufacturer, the product type, the lot in production, and the like.

Furthermore, there are provided a class certificate Cpy for a content reproduction circuit and a class certificate Cmw for a memory card or a license management module. These class certificates have different information for each content reproduction circuit class and each memory card or license management module class.

The content reproduction circuit has its public encryption class key and class certificate recorded therein in the form of authentication data {KPpy//Cpy}KPa when it is shipped, and the memory card or the license management module has its public encryption class key and class certificate recorded therein in the form of authentication data {KPmw//Cmw}KPa when it is shipped. As will later be described more specifically, KPa is a public encryption key shared throughout the distribution system of interest.

Furthermore, there exist a public encryption key KPmcx set for each memory card or license management module to provide an encryption process to safely deliver a license to the memory card and the license management module, and a private decryption key Kmcx unique to each and capable of decrypting data encrypted with public encryption key KPmcx. The public encryption and private decryption keys provided for each individual memory card or license management module will generally be referred to as an individual key, and public encryption key KPmcx and private decryption key Kmcx will be referred to as an individual public encryption key and an individual private decryption key, respectively.

When a license is communicated, encryption keys Ks1-Ks3 are used to keep the secret. Keys Ks1-Ks3 are symmetric keys generated in license distribution server 12, a content reproduction circuit, a memory card and a license management module whenever a license is distributed and content data is reproduced.

Herein, symmetric keys Ks1-Ks3 are unique symmetric keys generated for each “session” corresponding to a unit of communication or a unit of access between a license distribution server, a content reproduction circuit, a memory card and a license management module and will hereinafter also be referred to as “session keys.”

Session keys Ks1-Ks3 each has a unique value for each session. More specifically, session key Ks1 is generated by license distribution server 12 for each license distribution session. Session key Ks2 is generated by memory card 110 and the license management module for each distribution session and each reproduction session. Session key Ks3 is generated by the content reproduction circuit for each reproduction session. In each session, these session keys can be communicated and a session key generated by other equipment can be received and used to effect encryption and a license key or the like can then be transmitted to enhance security in the session.

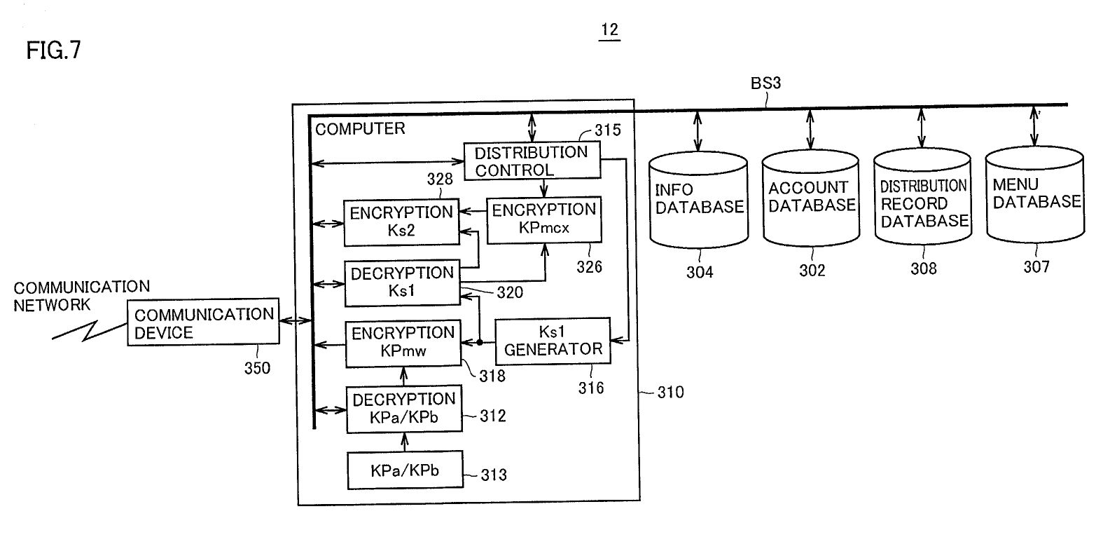

FIG. 7 is a schematic block diagram showing a configuration of the FIG. 1 license distribution server 12.

License distribution server 12 includes an information database 304 holding license key Kc, a content ID and other similar distribution information, an account database 302 holding account information for each personal computer user starting an access to a license, a menu database 307 holding a menu of a license held in information database 304, a distribution record database 308 holding a log of distributing a transaction ID and the like specifying a distribution for example of content data and a license key whenever a license is distributed, a data processing unit 310 receiving data from information database 304, account database 302, menu database 307 and distribution record database 308 through bus BS3 and effecting a predetermined process, and a communication device 350 allowing data communication between the Internet 20 and data processing unit 310.

Data processing unit 310 includes a distribution control unit 315 driven by data on bus BS3 to control an operation of data processing unit 310, a session key generator 316 controlled by distribution control unit 315 to generate session key Ks1 in a distribution session, an authentication key hold unit 313 holding public authentication key KPa provided to decrypt authentication data {KPmw//Cmw}KPa transmitted from a memory card for authentication, a decryption unit 312 receiving via communication device 350 and through bus BS3 the authentication data {KPmw//Cmw}KPa transmitted from the memory card, and decrypting the authentication data with public authentication key KPa provided from authentication key hold unit 313, a session key generator 316 generating session key Ks1 for each distribution session, an encryption unit 318 using public encryption class key KPmw obtained by decryption unit 312, to encrypt session key Ks1 generated by session key generation unit 316, for output on bus BS3, and a decryption unit 320 receiving through bus BS3 data transmitted that is encrypted with session key Ks1, and decrypting the received, encrypted data.

Data processing unit 310 further includes an encryption unit 326 encrypting license key Kc and access control information ACm received from distribution control unit 315, with public encryption key KPmcx obtained from decryption unit 320 and individual for each memory card, and an encryption unit 328 further encrypting an output of encryption unit 326 with session key Ks2 received from decryption unit 320, for output on bus BS3.

License distribution server 12 in a distribution session operates, as will later be described in detail with reference to a flow chart.

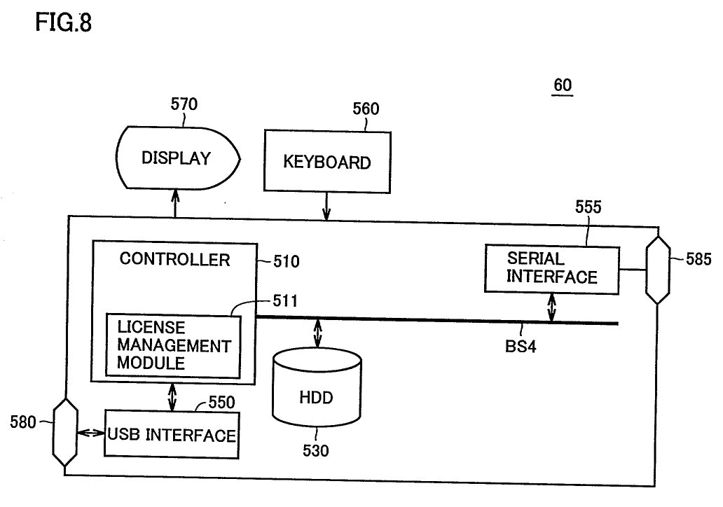

FIG. 8 is a schematic block diagram for illustrating a configuration of the FIG. 1 personal computer 60. Personal computer 60 includes a bus BS4 allowing data communication with various components of personal computer 60, a controller (CPU) 510 controlling personal computer 60 and also executing various programs, a hard disk (HDD) 530 connected to bus BS4 and serving as a large-capacity recording device provided to record and thus store programs, data and the like therein, a keyboard 560 operated to input an instruction from a user, and a display 570 visually presenting various information to the user.

Personal computer 60 further includes a USB interface 550 controlling data communication between controller 510 and a terminal 580 in communicating encrypted content data and a license for example to reproduction terminal 100, terminal 580 provided to connect USB cable 70, a serial interface 555 controlling data communication between controller 510 and terminal 585 in communicating with license distribution server 12 via the Internet 20 and net provider 50, and terminal 585 provided for connection with a modem (not shown) by a cable.

Controller 510 controls data communication with license distribution server 12 to allow license management module 511 to receive a license of encrypted content data from license distribution server 12 via the Internet 20. Furthermore, personal computer 60 also includes license management module 511 corresponding to a program executed by controller 510 and communicating various types of keys with license distribution server 12 to receive a license from license distribution server 12. It generates an encrypted, extended license, a license received from license distribution server 12 and uniquely encrypted to safely record the license in personal computer 60.

License management module 511 is a program having a function to establish an encryption communication path using the Internet 20 and communicating with license management server 12, and safely distributing a license through the encryption communication path, a function to uniquely encrypt and thus protect a distributed license and then store and thus manage the protected license in hard disk 530, and a function to transfer the managed license to memory card 110 or receive a license transferred from memory card 110. For its characteristics the license management module needs to be a program having an anti-tamper structure that can hardly be analyzed.

Furthermore the license management module may also function to decrypt encrypted content data with a managed license and reproduce the data.

Thus personal computer 60 incorporates therein license management module 511 receiving a license from license distribution server 12 on the Internet 20 and transmitting it to memory card 110.

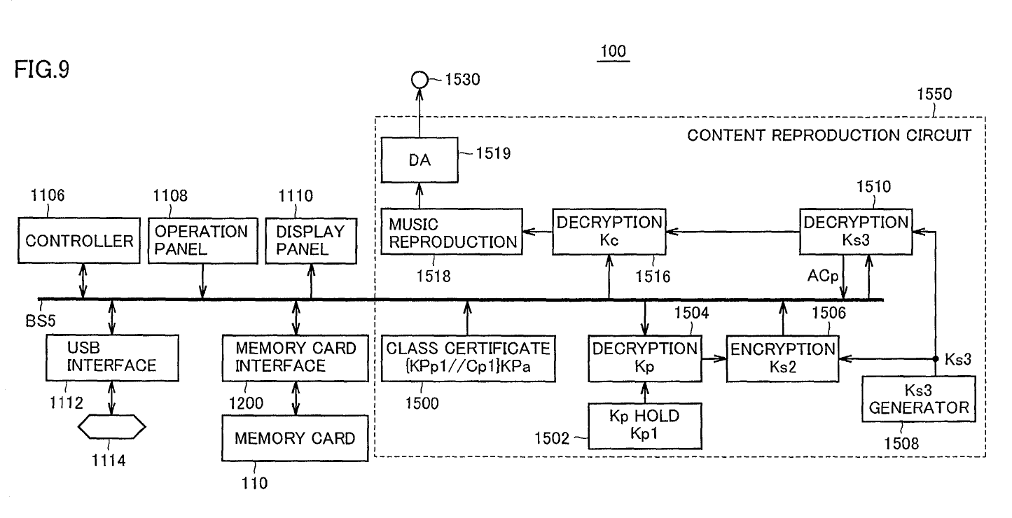

FIG. 9 is a schematic block diagram for illustrating a configuration of the FIG. 1 reproduction terminal 100.

Reproduction terminal 100 includes a bus BS5 allowing data communication with various components of reproduction terminal 100, a controller 1106 controlling an operation of reproduction terminal 100 through bus BS5, an operation panel 1108 operated to enter an external instruction to reproduction terminal 100, and a display panel 1110 visibly presenting to a user the information output from controller 1106 and the like.

Reproduction terminal 100 further includes a detachably attachable memory card 110 storing and decrypting content data (music data) received from license distribution server 12, a memory card interface 1200 controlling data communication between memory card 110 and bus BS5, a USB interface 1112 controlling data communication between bus BS5 and terminal 1114 in receiving encrypted content data and a license from personal computer 60, and a terminal 1114 provided to connect USB cable 70.

Reproduction terminal 100 further includes an authentication data hold unit 1500 holding authentication data {KPp1//Cp1}KPa, an encryption of public encryption class key KPp1 and class certificate Cp1 having authenticity verifiable when it is decrypted with public authentication key KPa. Herein a reproduction terminal 100 has a class y=1 for the sake of illustration.

Reproduction terminal 100 further includes a Kp hold unit 1502 holding a decryption key Kp1 unique to a class, and a decryption unit 1504 using decryption key Kp1 to decrypt data on bus BS5 to obtain session key Ks2 generated by memory card 110.

Reproduction terminal 100 further includes a session key generator 1508 using a random number or the like to generate session key Ks3 for encrypting data communicated with memory card 110 on data bus BS5 in a reproduction session reproducing content data stored in memory card 110, and an encryption unit 1506 using session key Ks2 obtained from decryption unit 1504, in receiving license key Kc and reproduction control information ACp from memory card 110 in a reproduction session reproducing encrypted content data, to encrypt session key Ks3 generated by session key generation unit 1508, for output on bus BS5.

Reproduction terminal 100 further includes a decryption unit 1510 using session key Ks3 to decrypt data on bus BS5 and outputting license key Kc and reproduction control information ACp, a decryption unit 1516 receiving encrypted content data {Dc}Kc from bus BS5, decrypting the received encrypted content data with license key Kc obtained from decryption unit 1510, and outputting content data, a music reproduction unit 1518 receiving an output of decryption unit 1516 and reproducing content data, a DA converter 1519 converting a digital signal output from music reproduction unit 1518 into an analog signal, and a terminal 1530 provided to output an output of DA converter 1519 to a headphone or any other similar external output device (not shown).

Note that in the FIG. 9 the dotted line surrounds a region configuring a content reproduction circuit 1550 decrypting encrypted content data to reproduce music data.

Reproduction terminal 100 has various components operating in each session, as will later be described in detail with reference to a flow chart.

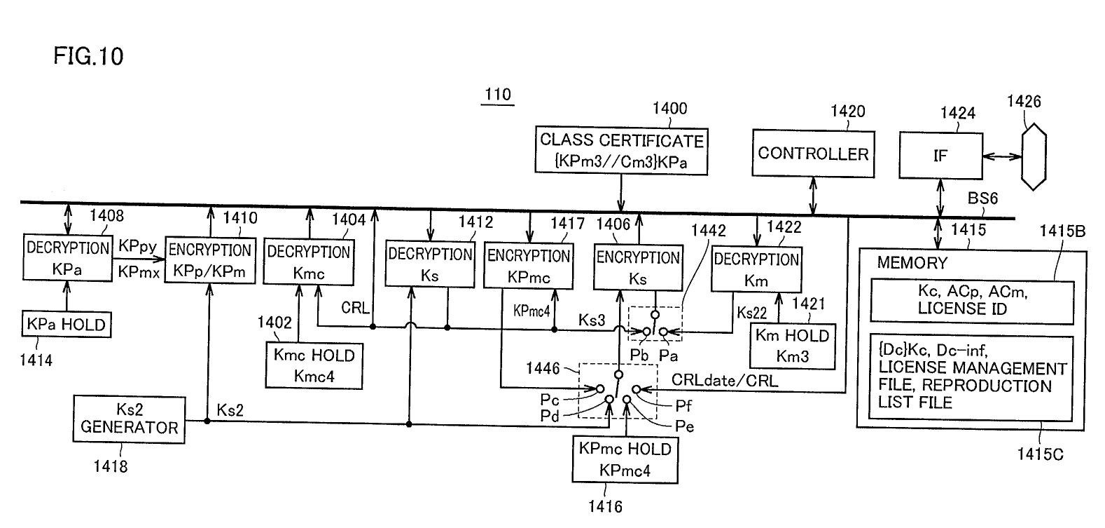

FIG. 10 is a schematic block diagram for illustrating a configuration of the FIG. 1 memory card 110.

As has been described previously, a memory card is provided with public encryption class key and secret decryption class key KPmw and Kmw, respectively, and a class certificate Cmw, and for memory card 110, natural number w=3 for the sake of illustration. Furthermore, the memory card is identified by a natural number x=4 for the sake of illustration.

Thus memory card 110 includes authentication data hold unit 1400 holding authentication data {KPm3//Cm3}KPa, a Kmc hold unit 1402 holding individual private decryption key Kmc4 serving as a decryption key set to be unique to each memory card, a Km hold unit 1421 holding secret decryption class key Km3, and a KPmc hold unit 1416 holding public encryption key KPmc4 decryptable by individual private decryption key Kmc4.

The provision of an encryption key of a recording device corresponding to a memory card allows a distributed license to be managed for each memory card, as will be described hereinafter.

Furthermore, memory card 110 also provides an encryption process identical to the license management module receiving a license distributed from license management server 12 and can thus also construct an encryption communication path directly together with license distribution server 12 for safely receiving a license via the Internet 20, personal computer 40 and reproduction terminal 100 provided in the form of a memory card writer.

Memory card 110 also includes an interface 1424 communicating a signal with memory card interface 1200 through terminal 1426, a bus BS6 communicating a signal with interface 1424, a decryption unit 1422 using secret decryption class key Km3 received from Km hold unit 1421, to decrypt data fed on bus BS6 via interface 1424, and outputting to a contact Pa a session key Ks 22 generated in personal computer 60, a decryption unit 1408 receiving public authentication key KPa from KPa hold unit 1414, effecting from data on bus BS6 a decryption process using public authentication key KPa, and outputting a result the decryption and an obtained class certificate to controller 1420 and an obtained public class key to encryption unit 1410, and an encryption unit 1406 using a key selectively provided through a switch 1442, to encrypt data selectively provided through a switch 1446, for output on bus BS6.

Memory card 110 also includes a session key generator 1418 generating session key Ks2 in each session of communication with personal computer and reproduction, an encryption unit 1410 using public encryption class key KPpy or KPmw obtained from decryption unit 1408, to encrypt session key Ks2 output from session key generation unit 1418, for output on bus BS6, a decryption unit 1412 receiving from bus BS6 data encrypted by session key Ks2, and decrypting the received, encrypted data with session key Ks2 obtained from session key generation unit 1418, and an encryption unit 1417 using an individual public encryption key KPmcx (≠4) of another memory card 110 decrypted by decryption unit 1412, to encrypt license key Kc and reproduction control information ACp read from memory 1415 in a reproduction session reproducing encrypted content data.

Memory card 110 further includes a decryption unit 1404 decrypting data on bus BS6 with individual private decryption key Kmc4 of memory card 110 paired with individual public encryption key KPmc4, and a memory 1415 receiving from bus BS6 encrypted content data {Dc}Kc, a license (Kc, ACp, ACm, a license ID) provided to reproduce encrypted content data {Dc}Kc, additional information Dc-inf, a reproduction list of encrypted content data and a license management file provided to manage a license, and storing them therein. Memory 1415 is configured for example of a semiconductor memory device. Furthermore, memory 1415 is formed of a license region 1415B and a data region 1415C. License region 1415B is provided to record a license therein. Data region 1415C is provided to record therein a license management file recording therein encrypted content data {Dc}Kc, information Dc-inf related to the encrypted content data and information required to manage a license, for each encrypted content data, and a reproduction list file recording therein basic information for accessing encrypted content data, a license and the like recorded in a memory card. The license management file and the reproduction list file will later be described more specifically.

License region 1415B stores a license therein by a unit referred to as an “entry” provided to record a license (license key Kc, reproduction control information ACp, access control information ACm, and a license ID) exclusively. If a license is accessed, an entry in which the license is stored or an entry in which a license or the like is to be recorded is designated by an entry number.

Memory card 110 also includes a controller 1420 communicating data externally through bus BS6 and receiving reproduction information and the like through bus BS6 to control an operation of memory card 110.

Note that license region 1415B is configured in an anti-tamper module region.

A description will now be provided of an operation of the FIG. 1 distribution system in each session.

Download

In the FIG. 1 distribution system a license of encrypted content data is distributed from license distribution server 12 of distribution server 10 to license management module 511 of personal computer 60, as will now be described.

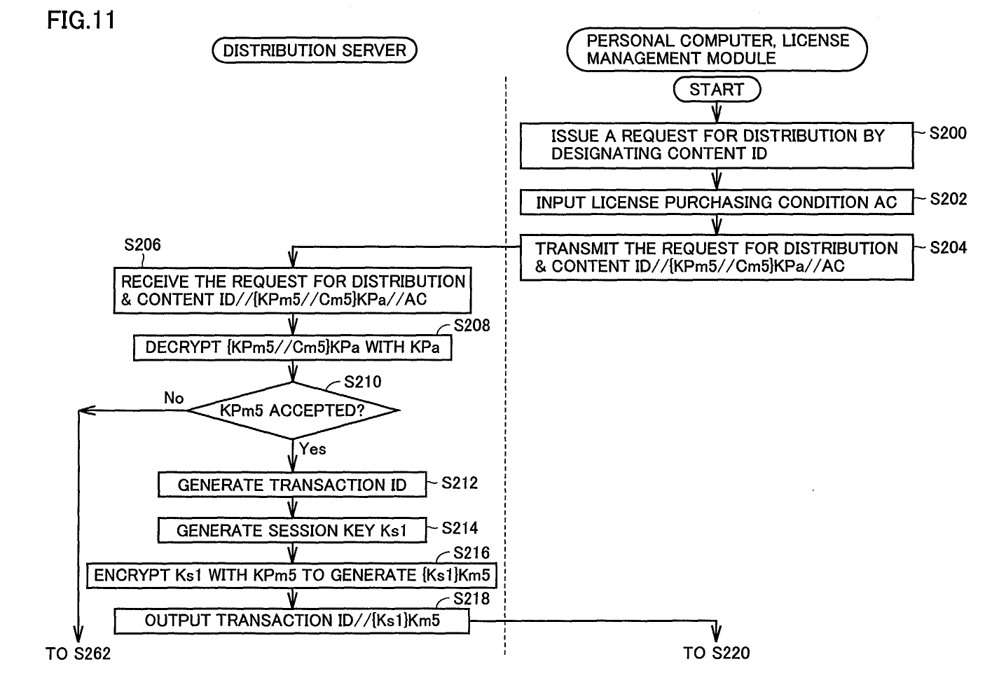

Prior to the FIG. 11 process, personal computer 60 downloads data {Dc}Kc//Dc-inf from personal computer 35 of net provider 30 via the Internet 20, and stores encrypted content data {Dc}Kc and additional information Dc-inf in hard disk 530 in the form of a content file. Furthermore, the user of personal computer 60 has connected with license distribution server 12 via a modem (not shown) and the user has already obtained from additional information Dc-inf stored in hard disk 530 a content ID of encrypted content data for which the user desires to purchase a license. Furthermore, the user of personal computer 60 also has already had the computer connected to license distribution server 12 according to information obtained from the additional information for connection with license distribution server 12.

FIGS. 11-14 are first to fourth flow charts, respectively, for illustrating an operation in the FIG. 1 distribution system to provide a distribution to license management module 511 incorporated in personal computer 60 that is effected in purchasing a license for encrypted content data. Note that license management module 511 receives a license from license distribution server 12 through a program. License management module 511 has a class represented by natural number w=5 and it is identified by natural number x=6 for the sake of illustration. Thus license management module 511 holds authentication data {KPm5//Cm5}KPa, individual public encryption key KPm6, secret decryption class key Km5 and individual private decryption key Kmc6.

With reference to FIG. 11, the user of personal computer 60 operates keyboard 560 to select encrypted content data {Dc}Kc, obtains from additional information Dc-inf a content ID corresponding to encrypted content data {Dc}Kc, and designates the obtained content ID to issue a request for distribution (step S200). Then keyboard 560 is operated to input purchase condition AC for purchasing a license of encrypted content data (step S202). More specifically, access control information ACm for encrypted content data and reproduction control information ACp are set and purchase condition AC is input to purchase license key Kc decrypting encrypted content data obtained from personal computer 35 of net provider 30.

When license purchasing condition AC is input, controller 510 reads authentication data {KPm5//Cm5}KPa from license management module 511 and transmits in addition to the read authentication data {KPm5//Cm5}KPa a content ID, license purchasing condition data AC and the request for distribution, to license distribution server 12 (step S204).

License distribution server 12 receives from personal computer 60 the request for distribution, the content ID, authentication data {KPm5//Cm5}KPa and license purchasing condition data AC (step S206). The received authentication data {KPm5//HCm5}KPa is decrypted by decryption unit 312 using public authentication key KPa (step S208).

Distribution control unit 315 effects an authentication process to determine from a result of the decryption in decryption unit 312 whether authentication data {KPm5//Cm5}KPa is authentication data encrypted by a proper authority for verifying its authenticity (step S210). If so then distribution control unit 315 approves and accepts public encryption key KPm5 and certificate Cm5. The control then moves on to step S212. If distribution control unit 315 determines that the authentication data of interest is not proper authentication data then it does not approve the same or accept public encryption key KPm5 or certificate Cm5 and terminates the process (step S272).

When public encryption key KPm5 and certificate Cm5 are accepted as a result of authentication, distribution control unit 315 generates a transaction ID corresponding to a management code for specifying a distribution (step S212). Furthermore, session key generation unit 316 generates session key Ks1 for distribution (step S214). Session key Ks1 is encrypted by encryption unit 318 using public encryption class key KPm5 obtained from decryption unit 312 and corresponding to license management module 511 (step S216).

The transaction ID and encrypted session key Ks1 are output in the form of transaction ID//{Ks1}Km5 externally through bus BS1 and via communication device 350 (step S218).

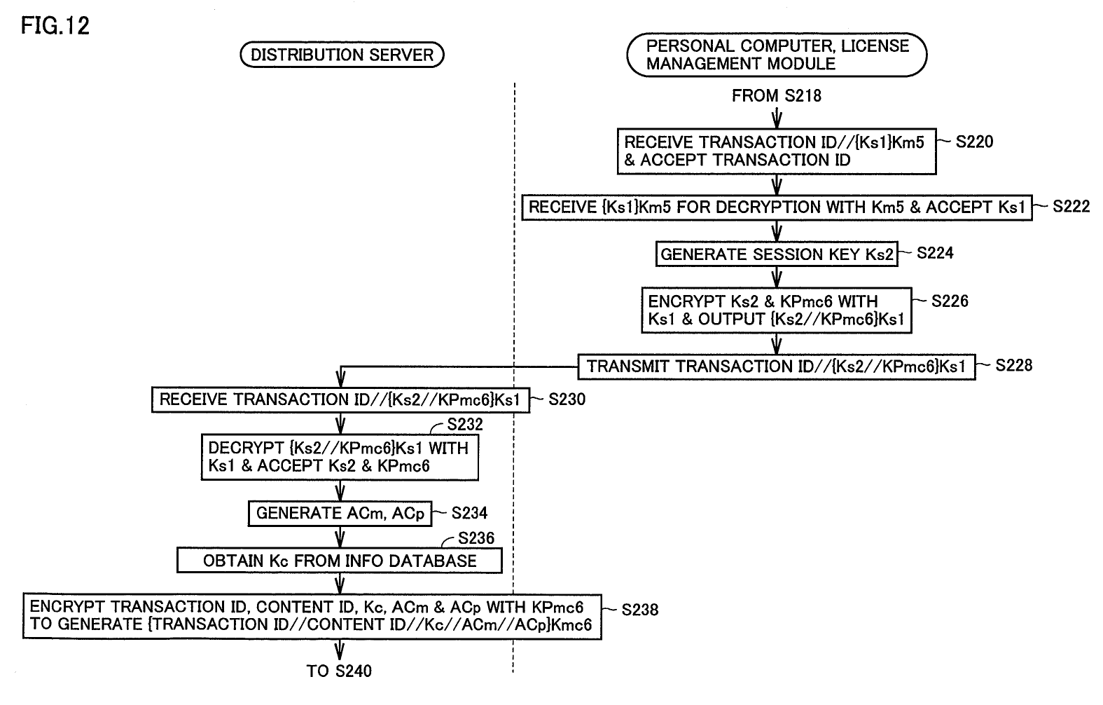

With reference to FIG. 12, when in personal computer 60 controller 510 receives transaction ID//{Ks1}Km5 (step S220), license management module 511 receives and decrypts encrypted data {Ks1}Km5 with secret decryption class key Km5 unique to license management module 511 and accepts session key Ks1 (step S222).

When the acceptance of session key Ks1 generated in distribution server 10 is confirmed, license management module 511 generates session key Ks2 (step S224). License management module 511 then uses session key Ks1 generated in license distribution server 12, to encrypt session key Ks2 generated in license management module 511 and individual public encryption key KPmc6 in a single data train to output encrypted data {Ks2//KPmc6} (step S226).

Controller 510 transmits encrypted data {Ks2//KPmc6} plus the transaction ID, i.e., transaction ID//{Ks2//KPmc6}Ks1 to license distribution server 12 (step S228).

License distribution server 12 receives transaction ID//{Ks2//KPmc6}Ks1 (step S230), at decryption unit 320 effects a decryption process using session key Ks1, and accepts session key Ks2 generated at license management module 511 and individual public encryption key KPmc6 unique to license management module 511 (step S232).

Distribution control unit 315 generates access control information ACm and reproduction control information ACp according to the content ID and license purchasing condition data AC obtained at step S206 (step S234). Distribution control unit 315 also obtains from information database 304 license key Kc for decrypting encrypted content data {Dc}Kc (step S236).

Distribution control unit 315 provides the generated license, i.e., the transaction ID, the content ID, license key Kc, reproduction control information ACp and access control information ACm to encryption unit 326. Encryption unit 326 uses public encryption key KPmc6 obtained by decryption unit 320 and unique to license management module 511, to encrypt the license to generate encrypted data {transaction ID//content ID//Kc//ACm//ACp}Kmc6 (step S238).

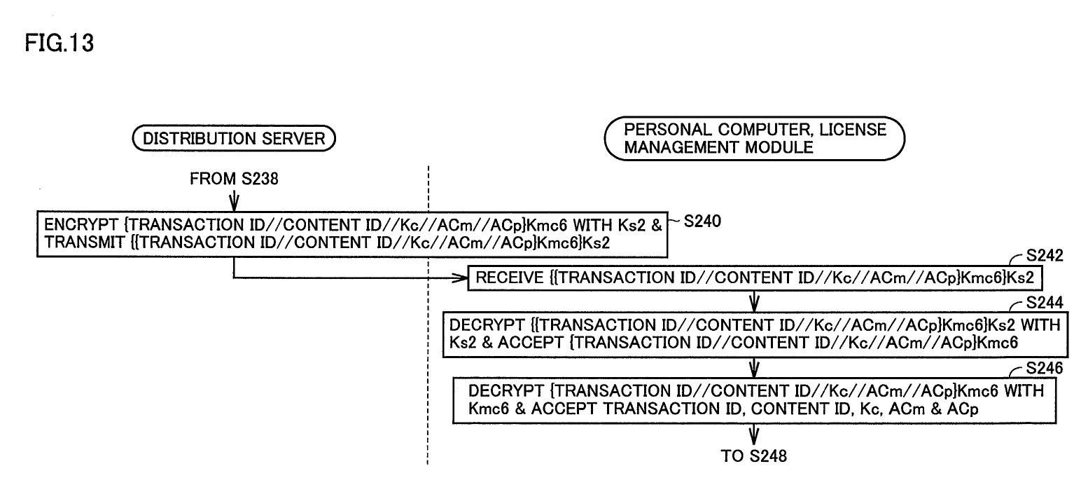

With reference to FIG. 13, in license distribution server 12 encryption unit 328 receives encrypted data {transaction ID//content ID//Kc//ACm//ACp}Kmc6 from encryption unit 326, encrypts it with session key Ks2 generated in license management module 511, and thus outputs encrypted data {{transaction ID//content ID//Kc//ACm//ACp}Kmc6}Ks2 on bus BS1. Distribution control unit 315 then transmits encrypted data {{transaction ID//content ID//Kc//ACm//ACp}Kmc6}Ks2 on bus BS1 to personal computer 60 via communication device 350 (step S240).

Then in personal computer 60 controller 510 receives encrypted data {{transaction ID//content ID//Kc//ACm//ACp}KmcG}Ks2 (step S242), and license management module 511 decrypts encrypted data {{transaction ID//content ID//Kc//ACm//ACp}Kmc6}Ks2 with session key Ks2 and accepts an encrypted license {transaction ID//content ID//Kc//ACm//ACp}Kmc6 (step S244). Encrypted license {transaction ID//content ID//Kc//ACm//ACp}Kmc6 is decrypted by private decryption key Kmc6, and a license (license key Kc, the transaction ID, the content ID, access control information ACm and reproduction control information ACp) is accepted (step S246).

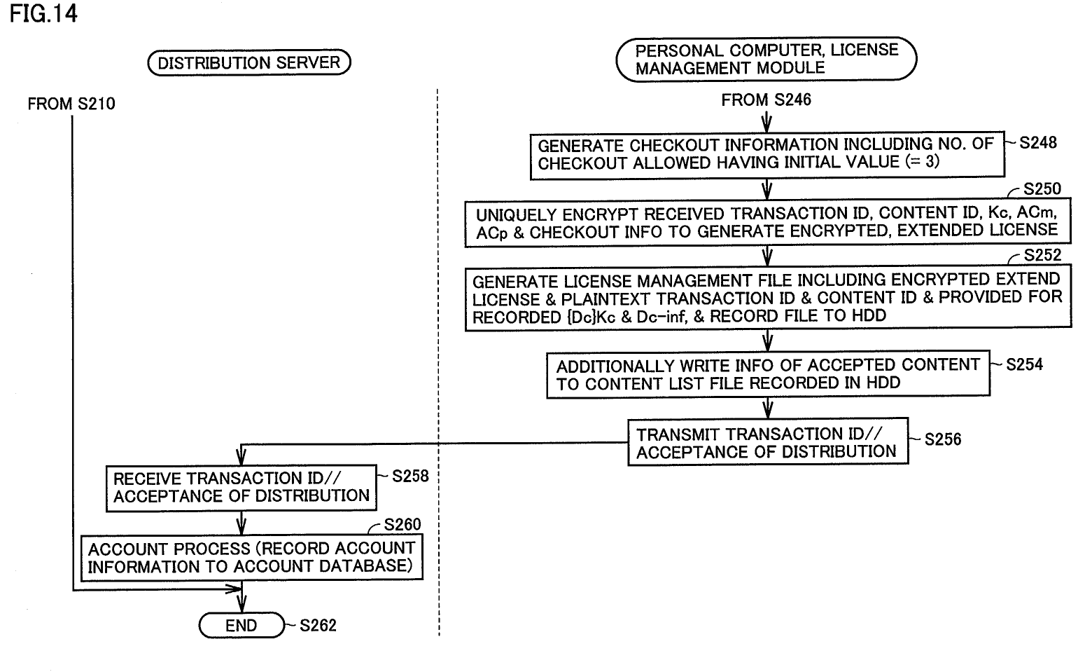

With reference to FIG. 14, license management module 511 generates checkout information including a number of times of checkout allowed to lend out to a different device the encrypted content data and license received from license distribution server 12 (step S248). In doing so, an initial checkout value of “3” is set. License management module 511 then generates an encrypted, extended license, a unique encryption of the received license (the transaction ID, the content ID, license key Kc, access control information ACm and reproduction control information ACp) and the generated checkout information (step S250). In doing so, license management module 511 provides the encryption based for example on an identification number of controller (CPU) 510 of personal computer 60. Thus the encrypted, extended license generated is a license unique to personal computer 60 and if the checkout operation as described hereinafter is not used neither encrypted content data nor a license can be transmitted to a different device.

Controller 510 then generates a license management file including the encrypted, extended license generated by license management module 511, the transaction ID in plaintext and the content ID, and provided for encrypted content data {Dc}Kc and additional information Dc-inf, and transmits the generated license management file through bus BS4 and records it to hard disk 530 (step S252). Furthermore, controller 510 additionally writes to a content list file recorded in hard disk 530 a name of a content file recorded and that of a license management file recorded and information of encrypted content data extracted from additional information Dc-inf (the title of the song of interest, the name of the artist) as information of content received (step S254) and transmits to license distribution server 12 the transaction ID and the acceptance of the distribution (step S256).

When license distribution server 12 receives transaction ID//acceptance of distribution (step S258) it stores account data to account database 302 and records the transaction ID to distribution record database 308, and provides a step to complete the distribution (step S206). Thus the entire process ends (step S262).

Thus license distribution server 12 and license management module 511 generate encryption keys, respectively, mutually communicate the encryption keys, use them to effect encryption, and mutually transmit the encrypted data. Thus in transmitting and receiving their respective encrypted data a mutual authentication can in effect also be provided to enhance the security of the data distribution system.

Checkout

In the FIG. 1 distribution system, encrypted content data and a license that have been downloaded from personal computer 35 or license distribution server 12 to license management module 511 of personal computer 60, are transmitted to memory card 110 attached to reproduction terminal 100, as will now be described. This operation will be referred to as “checkout.”

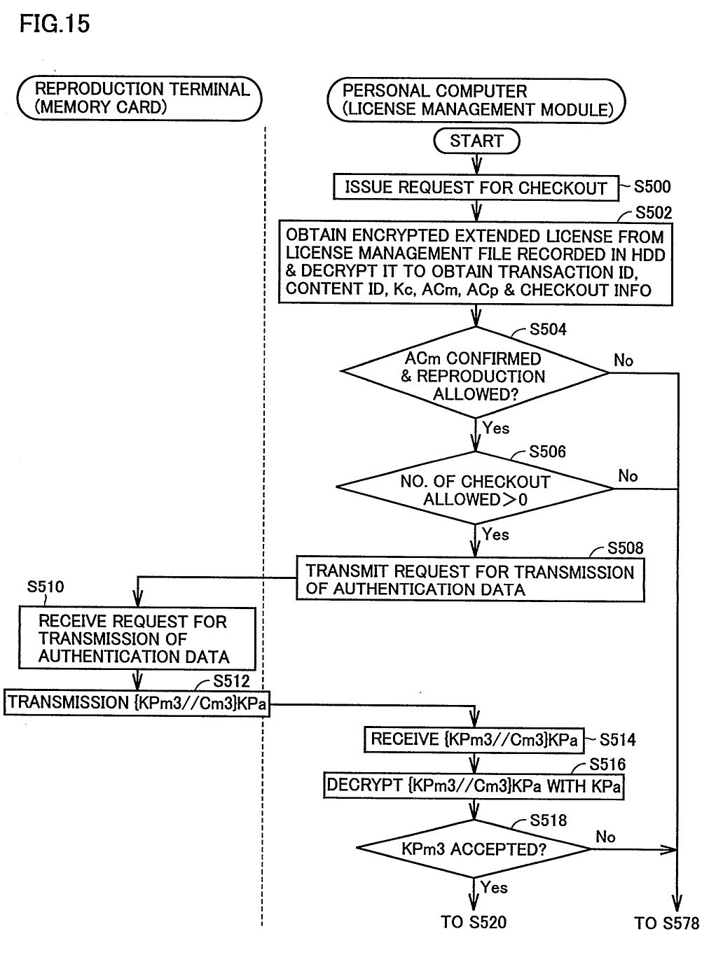

FIGS. 15-18 are first to fourth flow charts, respectively, for illustrating a checkout operation allowing the encrypted content data and license downloaded by license management module 511 to be lent out to memory card 110 attached to reproduction terminal 100, under the condition that they should be returned. Note that reproduction terminal 100 is not referred to in the flowcharts as it is equipment merely relaying data in the checkout operation.

Note that prior to the FIG. 15 process the user of personal computer 60 has already determined content to be checked out according to a content list file and a content file and a license management file have already been specified for the sake of illustration.

With reference to FIG. 15, when keyboard 560 of personal computer 60 is operated to input a request for a checkout (step S500) controller 510 obtains an encrypted, extended license from a license management file recorded in hard disk 530. The license management file is provided to store an encrypted, extended license, a unique encryption of encrypted content data and a license that are received by license management module 511 (see FIG. 14 at step S250). License management module 511 obtains from a license management file an encrypted, extended license of encrypted license data to be checked out, and decrypts it to obtain a license (a transaction ID, a content ID, license key Kc, access control information ACm and reproduction control information ACp) and checkout information (step S502).

License management module 511 then confirms access control information ACm (step S504). More specifically, license management module 511 refers to the obtained access control information ACm to determine whether a license to be checked out for memory card 110 attached to reproduction terminal 100 is associated with a number of times of reproduction of encrypted content data that is designated by access control information ACm or it is associated with encrypted content data disallowed to be reproduced. If reproduction is restricted, encrypted content data cannot be reproduced by a license checked out and it is thus useless to check out the encrypted content data and the license for memory card 110 attached to reproduction terminal 100.

If at step S504 reproduction is found restricted then control moves on to step S578 and the checkout operation ends. If at step S504 reproduction is not found restricted then the control moves on to step S506. License management module 511 then determines whether the obtained checkout information includes a number of times of checkout allowed larger than zero (step S506). If not, that means there is not any license left that can be checked out and the control moves on to step S578 and the checkout operation thus ends. If at step S506 the obtained checkout information indicates a number of times of checkout allowed greater than zero then license management module 511 signals to reproduction terminal 100 through USB interface 550, terminal 580 and USB cable 70 to request reproduction terminal 100 to transmit authentication data (step S508). In reproduction terminal 100 controller 1106 receives the request through terminal 1114, USB interface 1112 and bus BS5 and transmits the received request to memory card 110 through bus BS5 and memory card interface 1200. In memory card 110 controller 1420 receives the request through terminal 1426, interface 1424 and bus BS6 (step S510).

When controller 1420 receives the request it reads authentication data {KPm3//Cm3}KPa from authentication data hold unit 1400 through bus BS6 and outputs the read authentication data {KPm3//Cm3}KPa to reproduction terminal 100 through bus BS6, interface 1424 and terminal 1426. In reproduction terminal 100 controller 1106 receives authentication data {KPm3//Cm3}KPa through memory card interface 1200 and bus BS5 and transmits it to personal computer 60 through bus BS5, USB interface 1112, terminal 1114 and USB cable 70 (step S512).

Then in personal computer 60 license management module 511 receives authentication data {KPm3//Cm3}KPa through terminal 580 and USB interface 550 (step S514) and decrypts it with public authentication key KPa (step S516). License management module 511 determines from a result of the decryption process whether the process of interest has normally been effected, i.e., to authenticate that memory card 110 holds proper public encryption class key KPm3 and class certificate Cm3 license management module 511 effects an authentication process to determine whether authentication data encrypted by an authorizer for verifying authenticity thereof is received from memory card 110 (step S518). If so then license management module 511 approves and accepts public encryption class key KPm3 and class certificate Cm3 and moves on to a subsequent step (step S520). Otherwise, public encryption class key KPm3 and class certificate Cm3 are neither be approved nor accepted and the process thus ends (step S578).

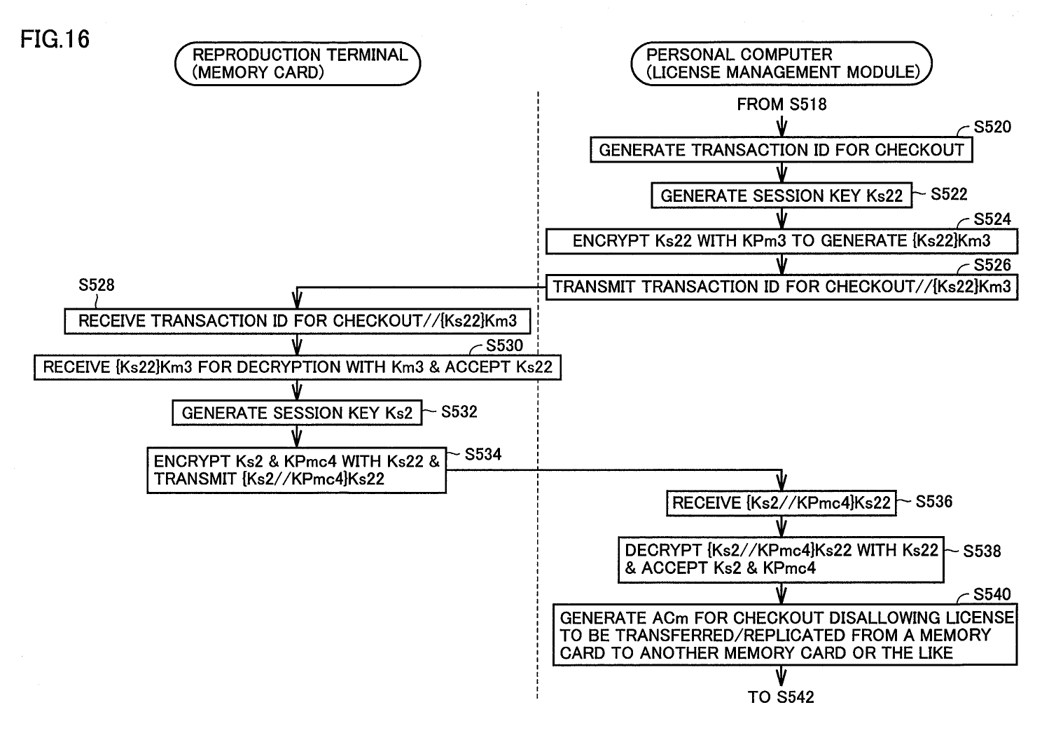

With reference to FIG. 16 if the authentication process reveals that a reproduction terminal having a memory card with proper authentication data is demanding an access then license management module 511 generates a transaction ID for checkout (step S520). This ID serves as a management code for specifying a checkout. A transaction ID for checkout has a different value from any other transaction ID stored in memory card 110 and it is generated as a transaction ID to be locally used. License management module 511 then generates session key Ks22 for checkout (step S522) and encrypts session key Ks22 with public encryption class key KPm3 transmitted from memory card 110 (step S524). License management module 511 then transmits encrypted data {Ks22}Km3 plus the transaction ID for checkout, i.e., transaction ID for checkout //{Ks22}Km3 to reproduction terminal 100 through USB interface 550, terminal 580 and USB cable 70 (step S526). Then in reproduction device 100 controller 1106 receives transaction ID for checkout //{Ks22}Km3 through terminal 1114, USB interface 112 and bus BS5 and transmits it to memory card 110 through memory card interface 1200. In memory card 110 controller 1420 receives transaction ID for checkout //{Ks22}Km3 through terminal 1426, interface 1424 and bus BS6 (step S528). Decryption unit 1422 receives encrypted data {Ks22}Km3 from controller 1420 through bus BS6, decrypts it with secret decryption class key Km3 received from Km hold unit 1421, and accepts session key Ks22 (step S530). Session key generation unit 1418 then generates session key Ks2 (step S532).

Then encryption unit 1406 uses session key Ks22 decrypted by decryption unit 1404, to encrypt session key Ks2 obtained by switching a terminal of switch 1446 successively and individual public encryption key KPmc4, to generate encrypted data {Ks2//KPmc4}Ks22. Controller 1420 outputs encrypted data {Ks2//KPmc4}Ks22 to reproduction terminal 100 through bus BS6, interface 1424 and terminal 1426 and in reproduction terminal 100 controller 1106 receives encrypted data {Ks2//KPmc4}Ks22 through memory card interface 1200. Controller 1106 then transmits encrypted data {Ks2//KPmc4}Ks22 to personal computer 60 through USB interface 1112, terminal 1114 and USB cable 70 (step S534).

In personal computer 60 license management module 511 receives encrypted data {Ks2//KPmc4}Ks22 through terminal 580 and USB interface 550 (step S536), decrypts the received encrypted data {Ks2//KPmc4}Ks22 with session key Ks22 and accepts session key Ks2 and individual public encryption key KPmc4 (step S538). License management module 511 then generates access control information ACm for checkout disallowing a license to be transferred/replicated from a memory card attached to reproduction terminal 100 to another memory card or the like. More specifically, it generates access control information ACm allowing reproduction as many times as desired (=255) and setting a transfer and replication flag to disallow transfer and replication (=3) (step S540).

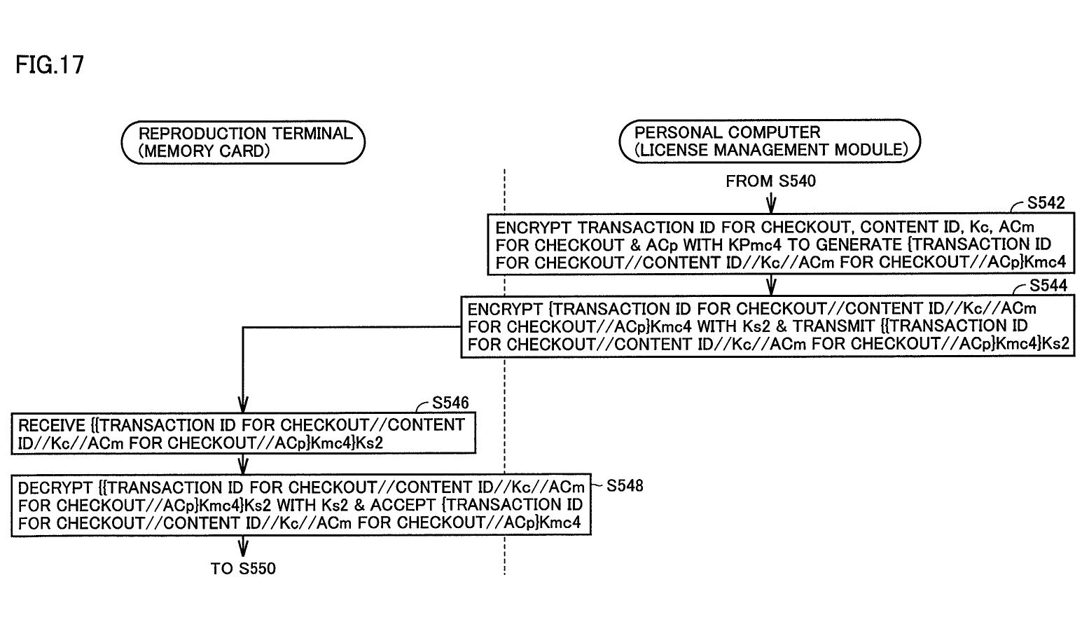

With reference to FIG. 17, license management module 511 uses public encryption key KPmc4 received at step S538 and unique to license management module 511, to encrypt a license to generate encrypted data {transaction ID for checkout//content ID//Kc//ACm for checkout//ACp}Kmc4 (step S542). License management module 511 then encrypts {transaction ID for checkout//content ID//Kc//ACm for checkout//ACp}Kmc4 with session key Ks2 and transmits encrypted data {{transaction ID for checkout//content ID//Kc//ACm for checkout//ACp}Kmc4}Ks2 to reproduction terminal 100 through USB interface 550, terminal 580 and USB cable 70 (step S544).

In reproduction terminal 100 controller 1106 receives encrypted data {{transaction ID for checkout//content ID//Kc//ACm for checkout//ACp}Kmc4}Ks2 through terminal 1114, USB interface 1112 and bus BS5 and transmits it to memory card 110 through bus BS5 and memory card interface 1200. Then in memory card 110 controller 1420 receives {{transaction ID for checkout//content ID//Kc//ACm for checkout//ACp}Kmc4}Ks2 through terminal 1426, interface 1424 and bus BS6 (step S546).

In memory card 110 decryption unit 1412 receives encrypted data {{transaction ID for checkout//content ID//Kc//ACm for checkout//ACp}Kmc4}Ks2 through bus BS6, decrypts it with session key Ks2 generated by session key generation unit 1418, and accepts an encrypted license {transaction ID for checkout//content ID//Kc//ACm for checkout//ACp}Kmc4 (step S548).

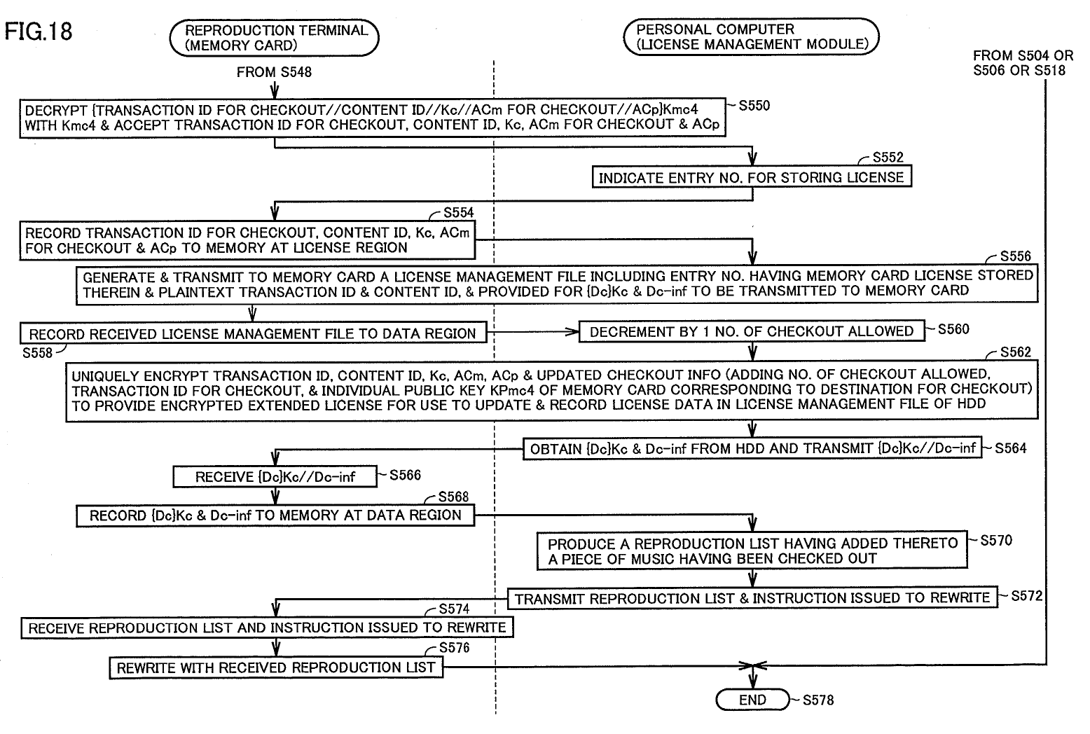

With reference to FIG. 18, according to an instruction of controller 1420 encrypted license {transaction ID for checkout//content ID//Kc//ACm for checkout//ACp}Kmc4 is decrypted by decryption unit 1404 using private decryption key Kmc4 and a license (license key Kc, the transaction ID for checkout, the content ID, ACm for checkout, and reproduction control information ACp) is accepted (step S550).

In personal computer 60 controller 510 transmits to reproduction terminal 100 through USB interface 550, terminal 580 and USB cable 70 an entry number provided to store a license transferred to memory card 110 (step S552). Then in reproduction terminal 100 controller 1106 receives the entry number through terminal 1114, USB interface 1112 and bus BS5 and transmits the received entry number to memory card 110 through bus BS5 and memory card interface 1200. Then in memory card 110 controller 1420 receives the entry number through terminal 1426, interface 1424 and bus BS6 and stores to memory 1415 at license region 1415B designated by the received entry number the license (license key Kc, the transaction ID for checkout, the content ID, ACm for checkout and reproduction control information ACp) obtained at step S550 (step S554).

In personal computer 60 controller 510 generates a license management file including the entry number of the license stored in memory card 110 at memory 1415, the transaction ID for checkout in plaintext and the content ID, and also provided for the encrypted content data {Dc}Kc and additional information Dc-inf to be transferred to memory card 110, and controller 510 transmits the generated license management file to memory card 110 (step S556).

In memory card 110 controller 1420 receives the license management file via reproduction terminal 100 and records it to memory 1415 at data region 1415C (step S558).

In personal computer 60 license management module 511 decrements by one the current number of times of checkout allowed (step S560), uniquely encrypts the transaction ID, the content ID, license key Kc, access control information ACm, reproduction control information ACp and updated checkout information (that having added thereto a number of times of checkout allowed, a transaction ID for checkout, and individual public encryption key KPmc4 of memory card 110 corresponding to the destination for the checkout) to generate a new encrypted extended license, and uses the generated encrypted license data to update and record license data of a license management file recorded in hard disk 530 (step S562). Individual public key KPmc4 of a destination for checkout is stored in a memory card at an anti-tamper module. It can be obtained by a communication means guaranteeing high security using an encryption through authentication and has a value unique to each memory card and it is thus suitably used as identification information specifying the memory card.

License management module 511 obtains from hard disk 530 the encrypted content data {Dc}Kc and additional information Dc-inf to be checked out for memory card 110 and transmits data {Dc}Kc//Dc-inf to memory card 110 (step S564). In memory card 110 controller 1420 receives data {Dc}Kc//Dc-inf via reproduction terminal 100 (step S566) through bus BS6 and records it to memory 1415 at data region 1415C as a content file (step S568).

Then in personal computer 60 license management module 511 produces a reproduction list having added thereto a piece of music checked out for memory card 110 (step S570) and transmits to memory card 110 the reproduction list and an instruction issued to rewrite a reproduction list (step S572). In memory card 110 controller 1420 receives the list and the instruction via reproduction terminal 100 (step S574) and uses a received reproduction list file to rewrite through bus BS6 a reproduction list file recorded in memory 1415 at data region 1415C (step S576) and the checkout operation ends (step S578).

Thus memory card 110 attached to reproduction terminal 100 is confirmed as proper equipment and public encryption key KPm3 successfully encrypted and transmitted together with class certificate Cm3 is also confirmed valid, and only then can content data be checked out and thus be prevented from checkout for any improper memory card.

Furthermore, a license management module and a memory card can generate encryption keys, respectively, mutually communicate the encryption keys, use them to effect encryption, and mutually transmit the encrypted data. Thus in transmitting and receiving their respective encrypted data a mutual authentication can in effect also be provided to enhance security in the operation checking out encrypted content data and a license.

Furthermore, if the checkout operation is provided, reproduction terminal 100 without a function to communicate with license distribution server 12 also allows a memory card to receive encrypted content data and a license that are received by personal computer 60 in software, which is more convenient for the user of such reproduction terminal 100.

Check-In

In the FIG. 1 distribution system, encrypted content data and a license that have been checked out of license management module 511 of personal computer 60 for memory card 110, are returned to license management module 511, as will now be described. Note that this operation will be referred to as “check-in.”

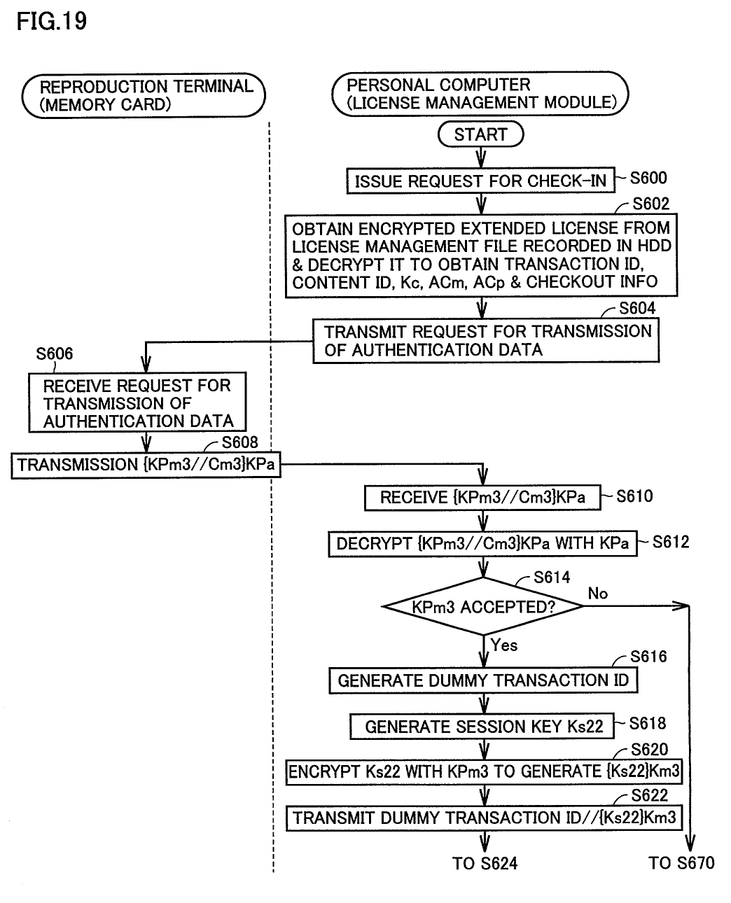

FIGS. 19-21 are first to third flow charts, respectively, for illustrating a check-in operation returning encrypted content data and a license that have been lent out to memory card 110 in the checkout operation described with reference to FIGS. 15-18. Reproduction terminal 100 is not referred to in the flow charts since it is equipment merely relaying data also in check-in.

Note that prior to the FIG. 19 process the user of personal computer 60 has already determined content to be checked in according to a content list file, and a content file and a license management file have already been specified for the sake of illustration.

With reference to FIG. 19, when keyboard 560 of personal computer 60 is operated to input a request for check-in (step S600) license management module 511 obtains an encrypted, extended license from a license management file recorded in hard disk 530 and decrypts it to obtain a license (a transaction ID, a content ID, license key Kc, access control information ACm and reproduction control information ACp) and checkout information (a number of times of checkout allowed, a transaction ID for checkout, and individual public encryption key KPmcx of a memory card corresponding to a destination for checkout) (step S602). License management module 511 then signals to reproduction terminal 100 through USB interface 550, terminal 580 and USB cable 70 to request reproduction terminal 100 to transmit authentication data (step S604). Then in reproduction terminal 100 controller 1106 receives the request through terminal 1114, USB interface 1112 and bus BS5 and transmits the received request to memory card 110 through bus BS5 and memory card interface 1200. In memory card 110 controller 1420 receives the request through terminal 1426, interface 1424 and bus BS6 (step S606).

When controller 1420 receives the request it reads authentication data {KPm3//Cm3}KPa from authentication data hold unit 1400 through bus BS6 and outputs the read authentication data {KPm3//Cm3}KPa to reproduction terminal 100 through bus BS6, interface 1424 and terminal 1426. In reproduction terminal 100 controller 1106 receives authentication data {KPm3//Cm3}KPa through memory card interface 1200 and bus BS5 and transmits it to personal computer 60 through bus BS5, USB interface 1112, terminal 1114 and USB cable 70 (step S608).

Then in personal computer 60 license management module 511 receives authentication data {KPm3//Cm3}KPa through terminal 580 and USB interface 550 (step S610) and decrypts it with public authentication key KPa (step S612). License management module 511 determines from a result of the decryption process whether the process of interest has normally been effected, i.e., to authenticate that memory card 110 holds proper public encryption class key KPm3 and class certificate Cm3 license management module 511 effects an authentication process to determine whether authentication data encrypted by an authorizer for verifying authenticity thereof is received from memory card 110 (step S614). If so then license management module 511 approves and accepts public encryption class key KPm3 and class certificate Cm3 and moves on to a subsequent step (step S616). Otherwise, public encryption class key KPm3 and class certificate Cm3 are neither be approved nor accepted and the process thus ends (step S670).

If the authentication operation reveals that the memory card of interest is a proper memory card then license management module 511 generates a dummy transaction ID (step S616). A dummy transaction ID has a different value from any transaction ID stored in memory card 110 and it is generated as a transaction ID to be locally used. License management module 511 then generates session key Ks22 for check-in (step S618) and uses public encryption class key KPm3 received from memory card 110 to encrypt the generated session key Ks22 to generate encrypted data {Ks22}Km3 (step S620) and transmits encrypted data {Ks22}Km3 plus the dummy transaction ID, i.e., dummy transaction ID//{Ks22}Km3 to reproduction terminal 100 through USB interface 550, terminal 580 and USB cable 70 (step S622).

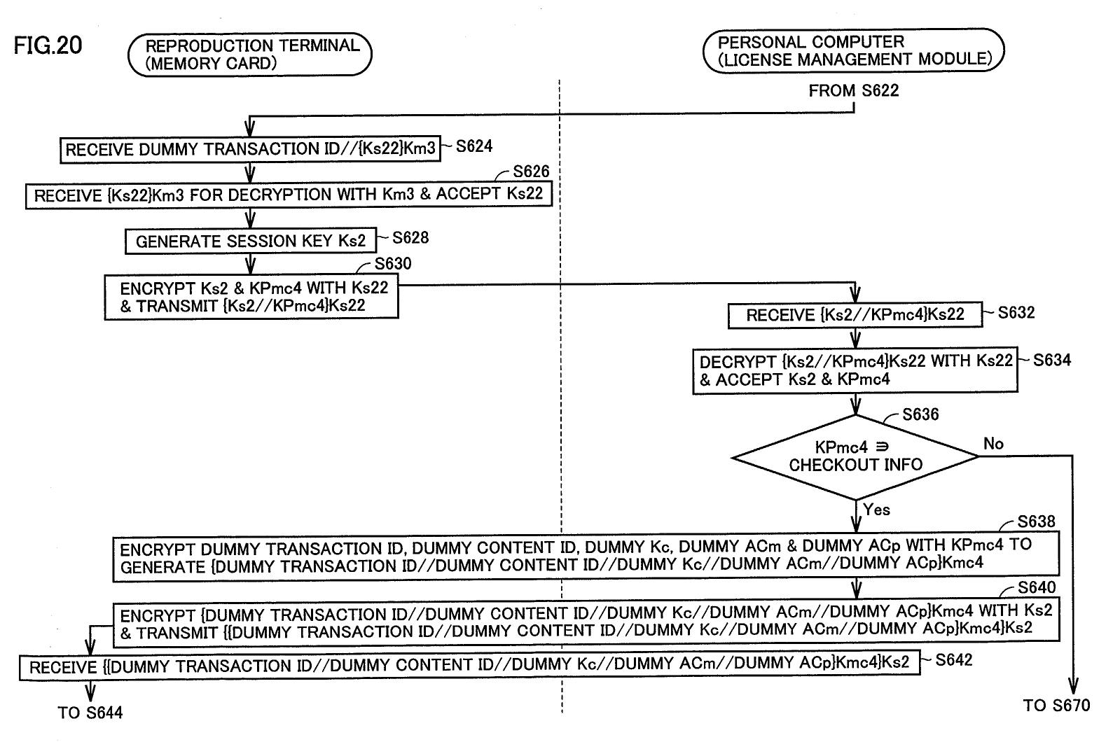

With reference to FIG. 20, in reproduction device 100 controller 1106 receives dummy transaction ID//{Ks22}Km3 through terminal 1114, USB interface 112 and bus BS5 and transmits it to memory card 110 through memory card interface 1200. In memory card 110 controller 1420 receives dummy transaction ID//{Ks22}Km3 through terminal 1426, interface 1424 and bus BS6 (step S624). Decryption unit 1422 receives encrypted data {Ks22}Km3 from controller 1420 through bus BS6, decrypts it with secret decryption class key Km3 received from Km hold unit 1421, and accepts session key Ks22 (step S626). Session key generation unit 1418 then generates session key Ks2 (step S628).

Then encryption unit 1406 uses session key Ks22 decrypted by decryption unit 1404 and obtained through terminal Pa of switch 1442, to encrypt session key Ks2 obtained by switching a terminal of switch 1446 successively and individual public encryption key KPmc4, to generate encrypted data {Ks2//KPmc4}Ks22. Controller 1420 outputs encrypted data {Ks2//KPmc4}Ks22 to reproduction terminal 100 through bus BS6, interface 1424 and terminal 1426 and in reproduction terminal 100 controller 1106 receives encrypted data {Ks2//KPmc4}Ks22 through memory card interface 1200. Controller 1106 then transmits encrypted data {Ks2//KPmc4}Ks22 to personal computer 60 through USB interface 1112, terminal 1114 and USB cable 70 (step S630).

In personal computer 60 license management module 511 receives encrypted data {Ks2//KPmc4}Ks22 through terminal 580 and USB interface 550 (step S632), decrypts the received encrypted data {Ks2//KPmc4}Ks22 with session key Ks22 and accepts session key Ks2 and individual public encryption key KPmc4 (step S634).

Then license management module 511 determines whether the received, individual public encryption key KPmc4 is included in the checkout information obtained from a license management file recorded in hard disk 530, i.e., whether it matches individual public encryption key KPmcx stored corresponding to a transaction ID for checkout that is associated with a license to be checked out (step S636). This individual public encryption key KPmc4 is included in updated checkout information when encrypted data and a license are checked out (see FIG. 18 at step S562). Thus by including in checkout information individual public encryption key KPmc4 corresponding to a destination for checking out encrypted content data and the like, the destination for checkout can readily be specified in check-in.

If at step S636 individual public encryption key KPmc4 is not included in the checkout information, the check-in operation ends (step S670). If at step S636 individual public encryption key KPmc4 is included in the checkout information then license management module 511 encrypts a dummy license including the dummy transaction ID (the dummy transaction ID, a dummy content ID, a dummy Kc, dummy ACm and dummy ACp) with individual public encryption key KPmc4 to generate encrypted data {dummy transaction ID//dummy content ID//dummy Kc//dummy ACm//dummy ACp}Kmc4 (step S638).

License management module 511 encrypts encrypted data {dummy transaction ID//dummy content ID//dummy Kc//dummy ACm//dummy ACp}Kmc4 with session key Ks2 to generate encrypted data {{dummy transaction ID//dummy content ID//dummy Kc//dummy ACm//dummy ACp}Kmc4}Ks2 and transmits the generated encrypted data {{dummy transaction ID//dummy content ID//dummy Kc//dummy ACm//dummy ACp}Kmc4}Ks2 to reproduction terminal 100 through USB interface 550, terminal 580 and USB cable 70 (step S640).

In reproduction terminal 100 controller 1106 receives encrypted data {{dummy transaction ID//dummy content ID//dummy Kc//dummy ACm//dummy ACp}Kmc4}Ks2 through terminal 1114, USB interface 1112 and bus BS5. Controller 1106 transmits the received encrypted data {{dummy transaction ID//dummy content ID//dummy Kc//dummy ACm//dummy ACp}Kmc4}Ks2 to memory card 110 through bus BS5 and memory card interface 1200. Then in memory card 110 controller 1420 receives encrypted data {{dummy transaction ID//dummy content ID//dummy Kc//dummy ACm//dummy ACp}Kmc4}Ks2 through terminal 1426, interface 1424 and bus BS6 (step S642).

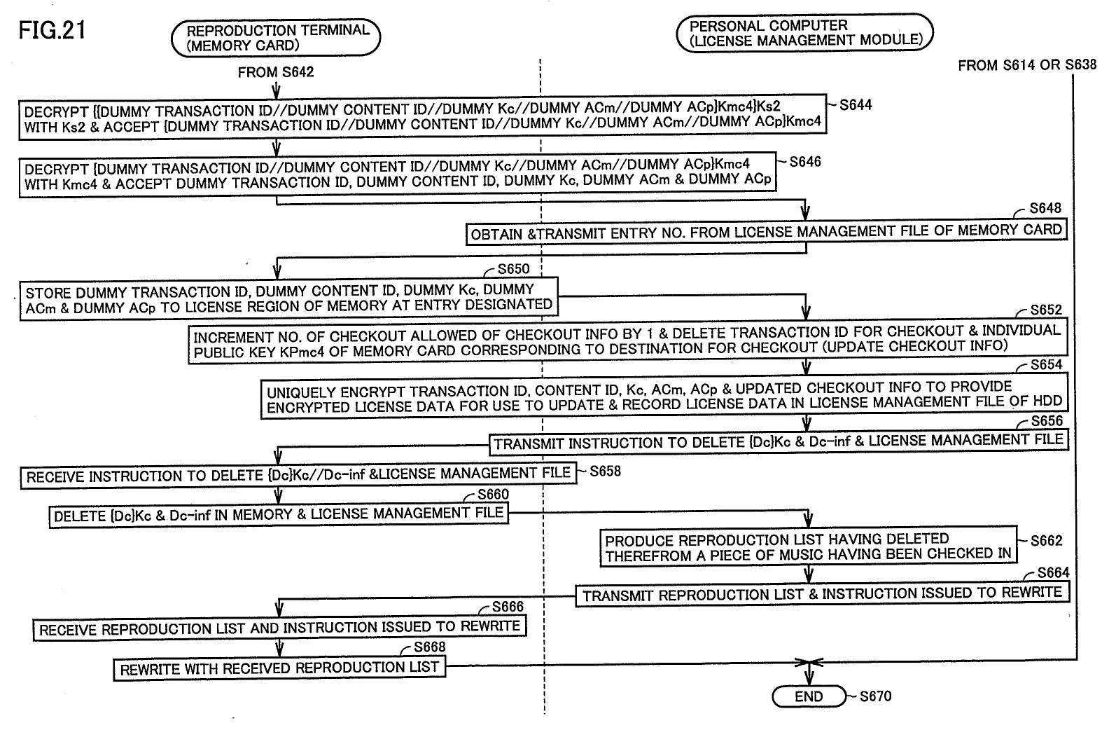

With reference to FIG. 21, in memory card 110 decryption unit 1412 receives encrypted data {{dummy transaction ID//dummy content ID//dummy Kc//dummy ACm//dummy ACp}Kmc4}Ks2 through bus BS6, decrypts it with session key Ks2 generated by session key generation unit 1418, and accepts encrypted data {dummy transaction ID//dummy content ID//dummy Kc//dummy ACm//dummy ACp}Kmc4 (step S644). Then decryption unit 1404 receives encrypted data {dummy transaction ID//dummy content ID//dummy Kc//dummy ACm//dummy ACp}Kmc4 from decryption unit 1412, decrypts it with individual private decryption key Kmc4 received from Kmc hold unit 1402, and accepts a dummy license (the dummy transaction ID, the dummy content ID, dummy Kc, dummy ACm and dummy ACp) (step S646).

In personal computer 60 controller 510 obtains an entry number from a license management file corresponding to a license checked out that is recorded in memory card 110 at data region 1415C, and controller 510 transmits the obtained entry number to reproduction terminal 100 through USB interface 550, terminal 580 and USB cable 70 as an entry number for storing the dummy license (step S648). Then in reproduction terminal 100 controller 1106 receives the entry number through terminal 1114, USB interface 1112 and bus BS5 and stores to memory 1415 at a license region 1415B designated by the received entry number the dummy license obtained at step S646 (the dummy transaction ID, the dummy content ID, dummy Kc, dummy ACm and dummy ACp) so that it stores the dummy license to license region 1415B at an entry designated. (step S650). Thus employing a dummy license to overwrite a license to be checked in can erase a license having checked out for memory card 110.

Then in personal computer 60 license management module 511 increments by one the current number of times of checkout allowed that is included in the checkout information, and deletes the transaction ID for checkout and individual public key KPmc4 of a memory card corresponding to a destination for checkout, to update the checkout information (step S652). License management module 511 then uniquely encrypts the transaction ID, the content ID, license key Kc, access control information ACm and reproduction control information ACp, and the updated checkout information to produce encrypted license data and updates and records license data of a license management file recorded in hard disk 530 (step S654).

Then license management module 511 transmits an instruction to reproduction terminal 100 through USB interface 550, terminal 530 and USB cable 70 to delete the content file (encrypted content data {Dc}Kc and additional information Dc-inf) and license management file for the license having been checked out that are recorded in the memory card 110 memory 1415 at data region 1415C (step S656). In reproduction terminal 100 controller 1106 receives the instruction through terminal 1114, USB interface 1112 and bus BS5 and outputs it to memory card 110 through bus BS5 and memory card interface 1200. Then in memory card 110 controller 1420 receives the instruction through terminal 1426, interface 1424 and bus BS6 (step S658). Then controller 1420 deletes through bus BS6 the content file (encrypted content data {Dc}Kc and additional information Dc-inf) and the license management file recorded in memory 1415 at data region 1415C (step S660).

In personal computer 60 license management module 511 produces a reproduction list having deleted therefrom a piece of music having checked in (step S662) and transmits to memory card 110 the reproduction list and an instruction issued to rewrite a reproduction list (step S664). In memory card 110 controller 1420 receives a reproduction list file and the instruction via reproduction terminal 100 (step S666) and uses the received reproduction list file to rewrite through bus BS6 a reproduction list file stored in memory 1415 at data region 1415C (step S668). Thus the check-in operation ends (step S670).

Thus, encrypted content data and a license that have once been checked out can be returned from the destination of the encrypted content data and the license. Thus, from a license management module of low security level prevented from transfer a license can be lent out to a memory card of high security level and the memory card can receive the license obtained via the license management module of low security level. Thus in a reproduction terminal the license obtained via the license management module of low security level can be used to reproduce and enjoy encrypted content data.

Furthermore, a license checked out and lent out to a memory card is designated according to access control information ACm not to be output from the memory card to another recording equipment, such as a memory card. Thus the license lent out does not leak. By checking in (returning) a license at the license management module having lent out the license, the right of the license lent out returns to the license management module having lent out the license. This does not permit replication against the copyright owner's will nor is it a process impairing security and the copyright of interest is also protected.

Reproduction

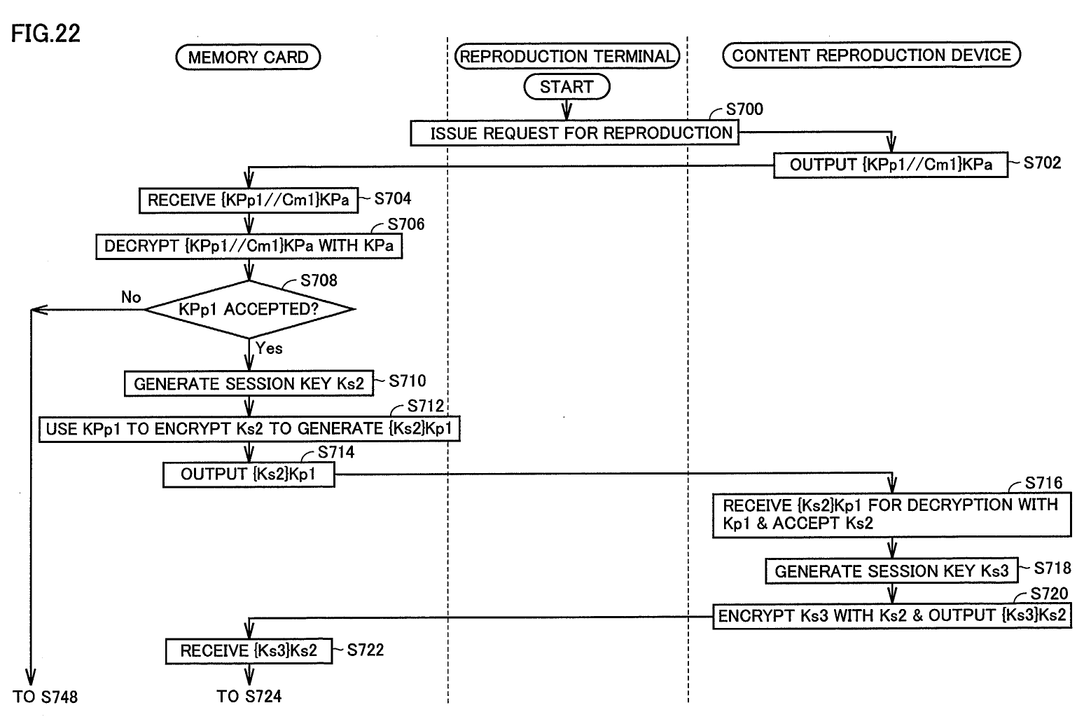

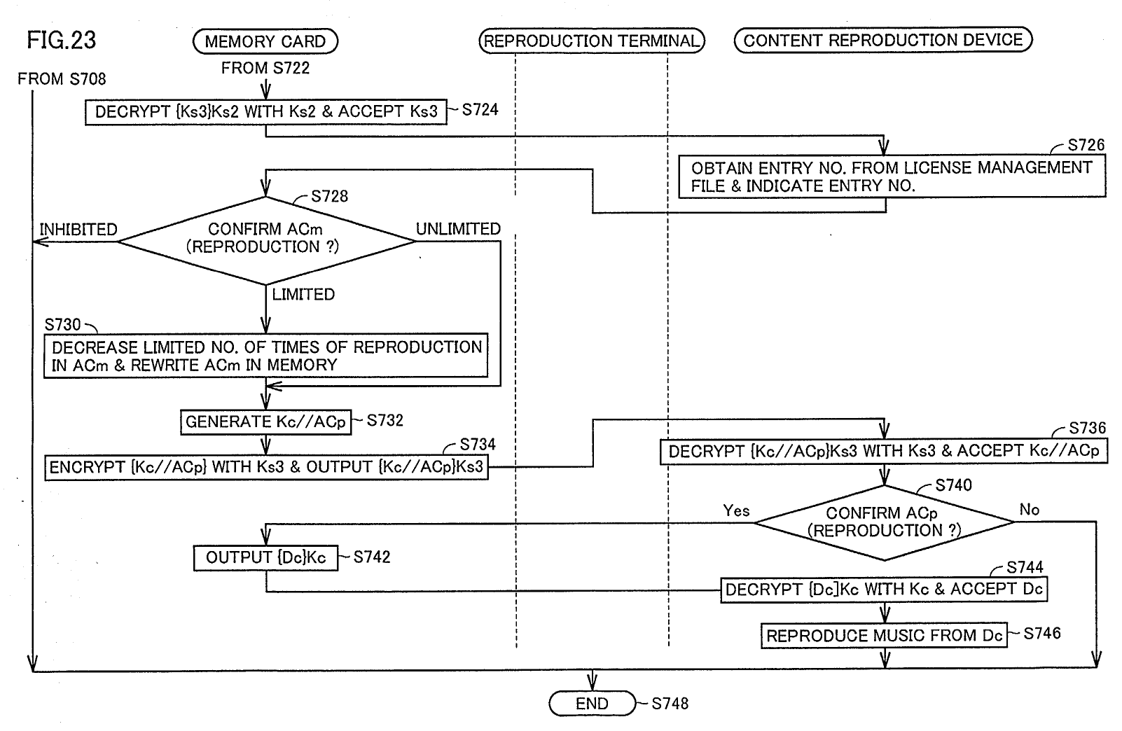

Reference will now be made to FIGS. 22 and 23 to describe an operation effected in reproduction terminal 100 (hereinafter also referred to as a content reproduction circuit) to reproduce content data checked out for memory card 110. Note that prior to the FIG. 22 process, the user of reproduction terminal 100 has already determined content (a piece of music) to be reproduced according to a reproduction list recorded in memory card 110 at data region 1415C and has already specified a content file and obtained a license management file for the sake of illustration.

With reference to FIG. 22, once the reproduction operation starts, the user of reproduction terminal 100 operates operation panel 1108 to input an instruction to reproduction terminal 100 to reproduce content data (step S700). Controller 1106 then reads authentication data {KPp1//Cp1}KPa from authentication data hold unit 1500 through bus BS5 and outputs it to memory card 110 through memory card interface 1200 (step S702).

Memory card 110 then accepts authentication data {KPp1//Cp1}KPa (step S704). Then in memory card 110 decryption unit 1408 decrypts the received authentication data {KPp1//Cp1}KPa with public authentication key KPa held in KPa hold unit 1414 (step S706) and controller 1420 effects an authentication process from a result of the decryption provided in decryption unit 1408. More specifically, controller 1420 effects the authentication process to determine whether authentication data {KPp1//Cp1}KPa is proper authentication data (step S708). If the data cannot be decrypted then the control moved on to step S748 and the reproduction operation ends. If the authentication data is successfully decrypted, session key generation unit 1418 generates session key Ks2 for a reproduction session (step S710). Then encryption unit 1410 outputs to bus BS6 session key Ks2 from session key generation unit 1418 that is encrypted by public encryption key KPp1 decrypted in decryption unit 1408, i.e., encrypted data {Ks2}Kp1 (step S712). Then controller 1420 outputs encrypted data {Ks2}Kp1 to memory card interface 1200 through interface 1424 and terminal 1426 (step S714). In reproduction terminal 100 controller 1106 obtains encrypted data {Ks2}Kp1 through memory card interface 1200. Then Kp hold unit 1502 outputs private decryption key Kp1 to decryption unit 1504.

Decryption unit 1504 uses private decryption key Kp1 output from Kp hold unit 1502 and paired with public encryption key KPp1, to decrypt encrypted data {Ks2}Kp1 and output session key Ks2 to encryption unit 1506 (step S716). Then session key generation unit 1508 generates session key Ks3 for a reproduction session and outputs session key Ks3 to encryption unit 1506 (step S718). Encryption unit 1506 uses session key Ks2 received from decryption unit 1504, to encrypt session key Ks3 received from session key generation unit 1508 and outputs encrypted data {Ks3}Ks2 and controller 1106 outputs encrypted data {Ks3}Ks2 to memory card 110 through bus BS5 and memory card interface 1200 (step S720).

Then in memory card 110 decryption unit 1412 receives encrypted data {Ks3}Ks2 through terminal 1426, interface 1424 and bus BS6 (step S722).

With reference to FIG. 23, decryption unit 1412 uses session key Ks2 generated by session key generation unit 1418, to decrypt encrypted data {Ks3}Ks2 and accepts session key Ks3 generated in reproduction terminal 100 (step S724).

In reproduction terminal 100 controller 1106 obtains a entry number stored of a license from a license management file of a song requested to be reproduced that has previously been obtained from memory card 110, and controller 1106 outputs the obtained entry number to memory card 110 through memory card interface 1200 (step S726).

When the entry number is input, controller 1420 responsively confirms access control information ACm (step S728).

At step S728, information of a restriction on memory access, or access control information ACm, is referred to, or, more specifically, a number of times of reproduction is confirmed and if access control information ACm indicates that reproduction is no longer allowed then the reproduction operation ends and if access control information ACm indicates a limited number of times of reproduction then the control updates (or decrements by one) the number of times of reproduction indicated in access control information ACm and then moves on to a subsequent step (step S730). If access control information ACm indicates that reproduction is allowed as many times as desired then the control skips step S730 and without updating the number of times of reproduction in access control information ACm moves on to a subsequent step (S732).

If at step S728 the control determines that reproduction is allowed in the reproduction operation of interest then are output on bus BS6 license key Kc and reproduction control information ACp for a song requested to be reproduced that are recorded in memory 1415 at license region 1415B (step S732).

The license key Kc and reproduction control information ACp obtained are transmitted to encryption unit 1406 past switched 1446 at a contact Pf. Encryption unit 1406 receives and encrypts license key Kc and reproduction control information ACp with session key Ks3 received from decryption unit 1412 past switch 1442 at a contact Pb and outputs encrypted data {Kc//ACp}Ks3 through bus BS6 (step S734).

The encrypted data output on bus BS6 is transmitted to reproduction terminal 100 through interface 1424, terminal 1426 and memory card interface 1200.

In reproduction terminal 100 encrypted data {Kc//ACp}Ks3 received through memory card interface 1200 is transmitted on bus BS5 and decrypted by decryption unit 1510, and license key Kc and reproduction control information ACp are accepted (step S736). Decryption unit 1510 transmits license key Kc to decryption unit 1516 and outputs reproduction control information ACp on to bus BS5.

Controller 1106 accepts reproduction control information ACp through bus BS5 and determines whether reproduction is allowed/disallowed (step S740).

If at step S740 the control determines from reproduction control information ACp that reproduction is disallowed then the reproduction operation ends.

If at step S740 the control determines that reproduction is allowed then controller 1106 requests memory card 110 through memory card interface 1200 to provide encrypted content data {Dc}Kc; Then in memory card 110 controller 1420 obtains encrypted content data {Dc}Kc from memory 1415 and outputs it to memory card interface 1200 through bus BS6, interface 1424 and terminal 1426 (step S742).

In reproduction terminal 100 controller 1106 obtains encrypted content data {Dc}Kc through memory card interface 1200 and provides it to decryption unit 1516 through bus BS5.

Then decryption unit 1516 uses license key Kc output from decryption unit 1510, to decrypt encrypted content data {Dc}Kc to obtain content data Dc (step S744).

Content data Dc decrypted is output to music reproduction unit 1518 which in turn reproduces the content data and DA converter 1519 converts a digital signal to an analog signal for output to terminal 1530. Then the music data is output through terminal 1530 and via an external output device to headphone 130 and reproduced (step S746). Thus the reproduction operation ends.

Thus personal computer 60 downloads from personal computer 35 of net provider 30 via the Internet 20 encrypted content data generated by personal computer 40 using license key Kc received from license management server 11, and downloads a license of the encrypted content data from license distribution server 12. Then reproduction terminal 100 receives in a checkout the encrypted content data and license downloaded by personal computer 60 and reproduces the same.

Thus in the present embodiment each user's personal computer can obtain content data from a CD and generates encrypted content data, and also provide the generated, encrypted content data to a site allowing a different user to obtain it. Thus encrypted content data can be circulated more freely.

In the above description, content data is encrypted and encrypted content data is decrypted and reproduced in a symmetric key system using license key Kc, although the present invention does not need to depend on the symmetric key system and it may use an asymmetric key such as in a public key infrastructure (PKI) system. If such a system is applied, an encryption key provided from a license management server encrypting content data to generate encrypted content data, and a decryption key provided from a license distribution server decrypting and reproducing encrypted content data, are asymmetric and not identical.

Furthermore in the above description the present invention provides an encryption process for content protection, it is not intended to limit the system of content protection. Furthermore, any method may be employed that provides an encryption process for implementing content protection that is capable of independently circulating encrypted content data and a license including a license key decrypting the encrypted content data.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A content provision device obtaining content data and using an encryption key to encrypt said content data to provide encrypted content data, comprising:
an interface controlling communication with a recording medium having said content data recorded therein;
a transmission and reception unit allowing external communication;
an encryption unit using said encryption key to encrypt said content data to generate said encrypted content data; and
a control unit obtaining said content data and identification information of said content data from said recording medium through said interface, transmitting said identification information via said transmission and reception unit to a license management server holding said encryption key, receiving said encryption key from said license management server via said transmission and reception unit, providing to said encryption unit said content data and said encryption key received, and providing externally via said transmission and reception unit said encrypted content data generated by said encryption unit.

2. The device of claim 1, wherein said control unit receives from said license management server via said transmission and reception unit additional information including information required for obtaining a decryption key provided to decrypt said encrypted content data, and provides said additional information externally together with said encrypted content data.

3. The device of claim 1, wherein when said control unit receives authentication data of said license management server via said transmission and reception unit, authenticates said authentication data received, and establishes a communication path communicating with said license management server, said control unit transmits said identification information to said license management server via said transmission and reception unit.

4. The device of claim 3, wherein said control unit communicates with said license management server in a predetermined encryption system.

5. The device of claim 1, further comprising an encoding unit encoding said content data in a predetermined system, said encoding unit encoding content data obtained from said recording medium, in said predetermined system to generate encoded content data, wherein said encryption unit receives said encoded content data from said encoding unit and encrypts said encoded content data with said encryption key to generate encrypted content data.

6. A method of providing content, comprising the steps of:
obtaining content data and identification information of said content data from a recording medium;
transmitting said identification information to a license management server;
receiving an encryption key from said license management server;
encrypting said content data with said encryption key to generate encrypted content data; and
externally outputting said encrypted content data generated.

7. The method of claim 6, wherein:
the step of receiving includes further receiving additional information including information required for obtaining a decryption key provided to decrypt said encrypted content data; and
the step of externally outputting includes externally outputting said additional information together with said encrypted content data.

8. The method of claim 6, wherein the step of transmitting includes transmitting said identification information to said license management server when said license management server is authenticated.

9. The method of claim 6, wherein the step of receiving includes allowing said license management server to communicate in a predetermined encryption system.

10. The method of claim 8, wherein the step of receiving includes allowing said license management server to communicate in a predetermined encryption system.

11. The method of claim 6, wherein the step of encrypting includes encoding said content data obtained in the step of obtaining, in said predetermined system to generate encoded content data, and then encrypting said encoded content data with said encryption key to generate said encrypted content data.

12. A license server providing an encryption key to a content provision device encrypting obtained content data and providing encrypted content data, comprising:
a transmission and reception unit allowing an external communication;
a database having stored therein a plurality of identification information corresponding to a plurality of content data, respectively, and said encryption key; and
a control unit receiving via said transmission and reception unit identification information of said content data transmitted from said content provision device, and reading from said database said encryption key corresponding to said identification information of said content data received, for transmission via said transmission and reception unit to said content provision device having transmitted said identification information of said content data.

13. The license server of claim 12, wherein said database has stored therein additional information corresponding to said plurality of content data, respectively, and including information required for obtaining a decryption key provided to decrypt content data encrypted in said content provision device using said encryption key, and transmits together with said encryption key said additional information corresponding to said encryption key.

14. The license server of claim 12, wherein if said control unit transmits said encryption key to said content provision device having transmitted said identification information of said content data, said control unit communicates with said content provision device in a predetermined encryption system.

15. The license server of claim 12, wherein:
said control unit further provides to at least one terminal device having received said encrypted content data from said content provision device a decryption key provided to decrypt said encrypted content data, receives via said transmission and reception unit said identification information of said content data transmitted from said terminal device, reads from said database a decryption key corresponding to said identification information of said content data received, and transmits said decryption key via said transmission and reception unit to said terminal device having transmitted said identification information of said content data; and
said database further has stored therein a plurality of decryption keys corresponding to said plurality of content data, respectively.

16. The license server of claim 15, wherein if said control unit transmits said decryption key to said terminal device having transmitted said identification information of said content data, said control unit communicates with said terminal device in a predetermined encryption system.
